(19) United States
(12) Patent Application Publication
(10) Pub. No.: US 2026/0353107 A1
(43) Pub. Date: Nov. 5, 2026

(54) UE PERFORMANCE ADJUSTMENT USING SPATIAL CONTEXTS

(71) Applicant: Samsung Electronics Co., Ltd., Suwon-si (KR)

(72) Inventors: Vutha Va, Plano, TX (US); Anum Ali, Frisco, TX (US); Yuqiang Heng, Plano, TX (US); Boon Loong Ng, Plano, TX (US)

(21) Appl. No.: 19/550,064

(22) Filed: Feb. 25, 2026

Related U.S. Application Data
(60) Provisional application No. 63/765,092, filed on Feb. 28, 2025.

(51) Int. Cl. H04W 24/02; H04W 24/10; H04W 72/044

(52) U.S. Cl. CPC H04W 24/02; H04W 24/10; H04W 72/046

(57) ABSTRACT

A method includes determining, by a first electronic device, a spatial context associated with the first electronic device. The method further includes identifying, by the first electronic device, an optimization mode for operation of the first electronic device based on the spatial context. The method additionally includes applying, by the first electronic device, the identified optimization mode for a duration in which the spatial context remains valid.

### CROSS-REFERENCE TO RELATED APPLICATION AND CLAIM OF PRIORITY

The present application claims priority under 35 U.S.C. § 119(e) to U.S. Provisional Patent Application No. 63/765,092 filed on Feb. 28, 2025, which is hereby incorporated by reference in its entirety.

### TECHNICAL FIELD

This disclosure relates generally to wireless networks. More specifically, this disclosure relates to a method and apparatus for user equipment (UE) performance adjustment using spatial contexts in wireless communications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for UE performance adjustment using spatial contexts in wireless communications.

In one embodiment, a method includes determining, by a first electronic device, a spatial context associated with the first electronic device. The method further includes identifying, by the first electronic device, an optimization mode for operation of the first electronic device based on the spatial context. The method additionally includes applying, by the first electronic device, the identified optimization mode for a duration in which the spatial context remains valid.

In another embodiment, a first electronic device is provided. The first electronic device includes a memory and a processor operably coupled to the memory. The processor is configured to determine a spatial context associated with the first electronic device, identify an optimization mode for operation of the first electronic device based on the spatial context; and apply the identified optimization mode for a duration in which the spatial context remains valid.

In yet another embodiment, a non-transitory computer readable medium embodying a computer program is provided. The computer program includes program code that, when executed by a processor of a first electronic device, causes the first electronic device to: determine a spatial context associated with the first electronic device, identify an optimization mode for operation of the first electronic device based on the spatial context; and apply the identified optimization mode for a duration in which the spatial context remains valid.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example network device in accordance with example embodiments of the present disclosure;

FIG. 5 illustrates an example process for optimizing the UE performance using spatial contexts in wireless communication systems in accordance with example embodiments of the present disclosure;

FIG. 6 illustrates an example process for optimizing the UE performance using abstract spatial contexts in wireless communication systems in accordance with example embodiments of the present disclosure;

FIG. 7 illustrates an example process for optimizing the UE performance using a private place context in wireless communication systems in accordance with example embodiments of the present disclosure;

FIG. 8A illustrates an example process of the RRM reduction optimization mode in wireless communication systems in accordance with example embodiments of the present disclosure;

FIG. 8B illustrates an example process of the RRM reduction optimization mode in wireless communication systems in accordance with example embodiments of the present disclosure;

FIG. 8C illustrates an example process of the RRM reduction optimization mode in wireless communication systems in accordance with example embodiments of the present disclosure;

FIG. 9 illustrates an example process for optimizing the UE performance using a public place context in wireless communication systems in accordance with example embodiments of the present disclosure;

FIG. 10 illustrates an example process for optimizing the UE performance using an in-vehicle context in wireless communication systems in accordance with example embodiments of the present disclosure;

FIG. 11 illustrates an example process for optimizing the UE performance using an in-vehicle context in wireless communication systems in accordance with example embodiments of the present disclosure;

FIG. 12 illustrates an example process for optimizing the UE performance using absolute spatial contexts in wireless communication systems in accordance with example embodiments of the present disclosure;

FIG. 13 illustrates an example process for data recording for on-device learning using absolute spatial contexts in wireless communication systems in accordance with example embodiments of the present disclosure;

FIG. 14 illustrates an example process for updating the on-device learning component for UE performance optimization in wireless communication systems in accordance with example embodiments of the present disclosure;

FIG. 15 illustrates an example process for determining consistency of cellular information in a spatial context in wireless communication systems in accordance with example embodiments of the present disclosure;

FIG. 16 illustrates an example diagram depicting CE latency in detecting spatial contexts in wireless communication systems in accordance with example embodiments of the present disclosure;

FIG. 17A illustrates an example processes for mobility assessment in wireless communication systems in accordance with example embodiments of the present disclosure;

FIG. 17B illustrates an example processes for mobility assessment in wireless communication systems in accordance with example embodiments of the present disclosure;

FIG. 18 illustrates an example process for applying disruptive optimization modes in wireless communication systems in accordance with example embodiments of the present disclosure;

FIG. 19 illustrates an example process for using spatial contexts as an anchor point for on-device learning for UE performance optimization in wireless communication systems in accordance with example embodiments of the present disclosure;

FIG. 20 illustrates an example process for using spatial contexts as an anchor point for on-device learning for UE performance optimization in wireless communication systems in accordance with example embodiments of the present disclosure;

FIG. 21 illustrates an example process for using spatial contexts as an anchor point for on-device learning for UE performance optimization in wireless communication systems in accordance with example embodiments of the present disclosure; and

FIG. 22 illustrates a flow chart of a method for UE performance adjustment using spatial contexts in wireless communication systems in accordance with example embodiments of the present disclosure.

### DETAILED DESCRIPTION

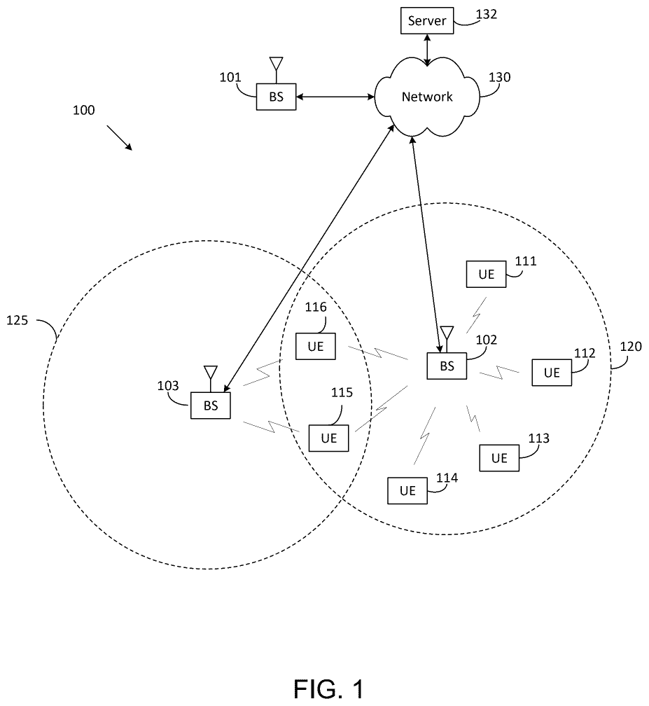

FIGS. 1 through 22, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of UE performance adjustment techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 via backhaul/network interfaces and train an AI model to support UE performance adjustment using spatial contexts. The server 132 may represent one or more servers, and each server 132 includes a suitable computing or processing device for training the AI/ML model. Each server 132 could, for example, include one or more processing devices, one or more memories storing instructions and data, and one or more network interfaces to receive the data.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support UE performance adjustment using spatial contexts in wireless communications. In certain embodiments, one or more of the gNBs 101-103 include circuitry, programing, or a combination thereof, to perform power savings with on-device learning in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

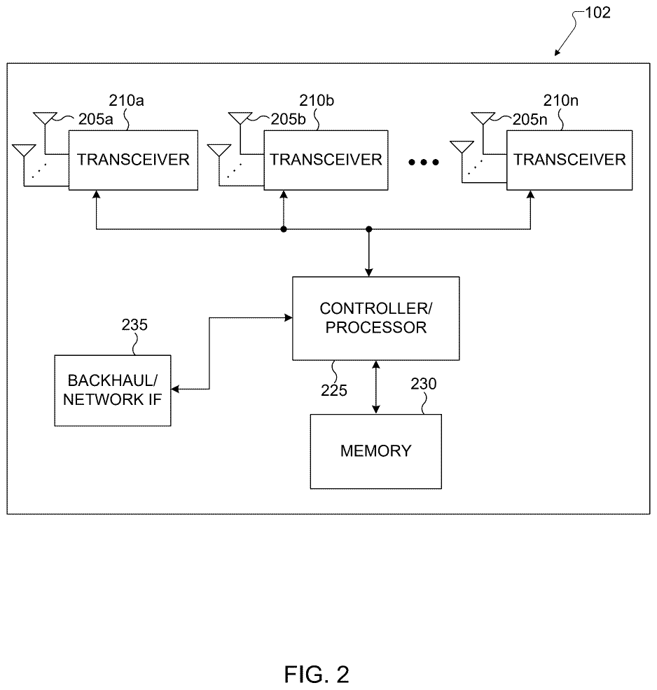

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support UE performance adjustment using spatial contexts in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

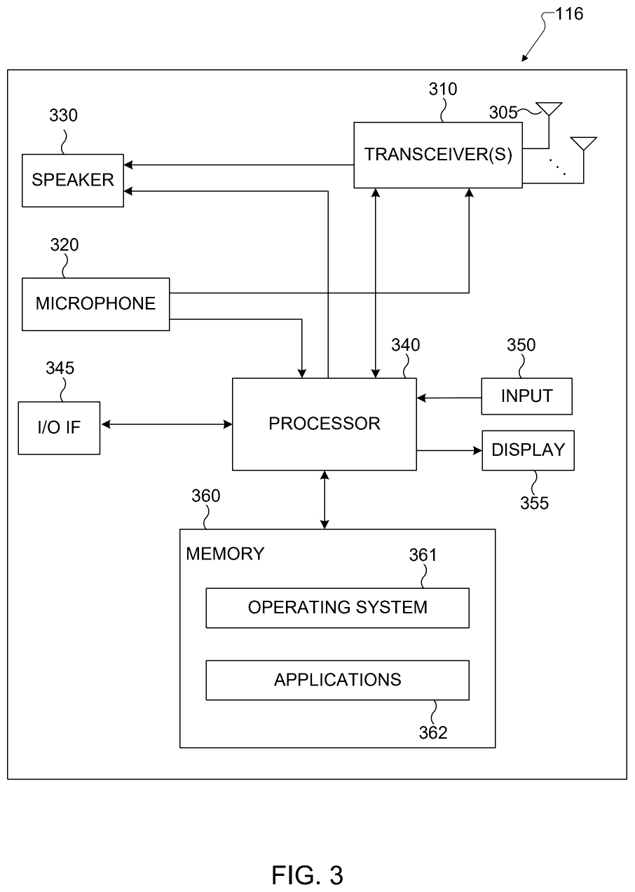

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support UE performance adjustment using spatial contexts in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

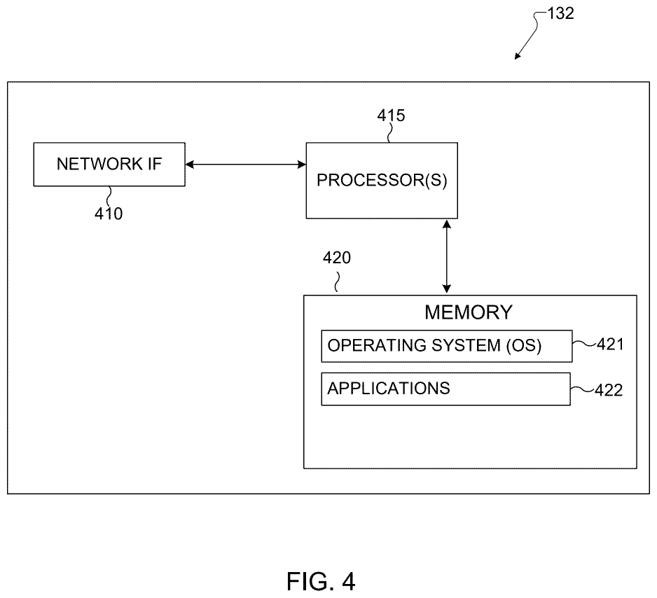

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources for training the neural network.

The processor 415 is also capable of executing other processes and programs resident in the memory 420, such as operations that receive and store data. As described in greater detail below, the processor 415 may execute processes to support UE performance adjustment using spatial contexts in wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

In modern cellular systems, such as those described regarding FIGS. 1-4, the 3GPP specifications may leave most of the configuration decisions to the network or BS side. This design may have been in part due to the limited capabilities of mobile devices in the early generations. There have been tremendous progresses since then and this assumption of ‘dumb mobile devices’ may be no longer valid, especially after the introduction of smartphones. Modern mobile devices such as smartphones may be equipped with numerous sensors and have substantial compute power and memory. This may offer a new venue for optimizing the cellular performance by utilizing the intelligence that may be provided by modern mobile devices. At the same time, the 3GPP 5G NR specifications may also offer new features that may nurture this approach of leveraging UE intelligence. Embodiments of the present disclosure recognize a feature called UAI (UE Assistance Information). The UAI may allow the UE with the knowledge of the applications running and/or environment/network constraints on the UE side to optimize cellular link parameters (e.g., maintaining the user experience while saving the UE power). The UAI may also allow the UE to convey a desired link configuration including:
Delay budget
Overheating assistant information
In-device coexistence
Preferred DRX (Discontinuous Reception) configuration
Preferred maximum aggregated bandwidth
Preferred maximum number of secondary CCs
Preferred maximum number of MIMO layers
Preferred scheduling offset and cross-slot scheduling
Preferred RRC state.

These features that allow an input from the UE or leave some decisions about the configurations to the UE may expand further in the future releases of the 3GPP specifications, especially towards the native AI vision of 6G.

Definitions and concepts relevant to this disclosure are provided here. “Context” is a broad term encapsulating a wide range of related information for optimizing the user experience. It may include information about the user, the user's activities, and the surrounding environment. One particularly useful context type for optimizing the cellular performance for the UE may be spatial context. Spatial context may provide some information about the surrounding environment and may also be utilized as a location marker that allows the UE to learn important properties of the serving network (NW) such as the capability supportable for the location. The UE may then utilize such information to optimize its performance. The contexts may constitute ‘free’ information that may be utilized to optimize the UE performance since these contexts may be detected by a context engine that operates continuously on the UE and provided at no additional cost to the cellular modem.

A context engine (CE) may ingest various information available on the device (the UE) to infer useful contexts for optimizing the user experience. The input information may include user input information (e.g., user profile), sensor readings (e.g., IMU, GPS, microphone, camera, various connectivity modules such as Bluetooth®, WiFi®, and cellular), other relevant information about date and time, etc. For most types of contexts, it may require time to accumulate relevant input information before a reliable context inference is possible. In this disclosure, a main property of the CE that affects the optimization approaches may be the delay in the detection of the context. Consider, e.g., a spatial context that signifies a bedroom in a home of a user. The CE may not be able to detect that the user is in the bedroom right after the user steps into the bedroom. It may need to accumulate various information before the CE can make the inference to obtain the context that the device is in the bedroom. For example, if the device is WiFi® fingerprint based, the relevant access points may be scanned, actively or passively. This latency in the detection of the context may depend on both the context and the device state (e.g., whether the device is in an active or idle state). For the spatial context, the latency may be in a range of a few tens of seconds.

The spatial context may be divided into two types: abstract spatial context and absolute spatial context. The abstract spatial context may provide a description of the environment without directly connecting itself to a specific physical location. Examples of the abstract spatial context may include ‘grocery store,’ ‘shopping mall,’ ‘theater/cinema,’ ‘stadium,’ etc. They may provide information about the surrounding environments. For example, in a shopping mall context, many people may be expected to be moving around, wherein in a theater context, many people may be expected to be around, but mostly static (e.g., in their seats). An absolute spatial context may tie directly to a physical location. For example, an office space or a home may be divided into multiple zones where each zone may have a unique identification (ID). This ID may be the absolute spatial context. The CE may output either one or both of the abstract spatial context and the absolute spatial context. For example, if the user is visiting a shopping mall for the first time, there might be no past history of the location, and thus the CE may not identify the spatial context as an absolute spatial context yet. However, the CE may be able to use other information such as density of surrounding users (e.g., background noise, observable Bluetooth® devices, etc.) to determine that this is a shopping mall and identify the spatial context as an abstract spatial context. On the other hand, for a local shopping mall that the user frequently visits, the CE may have the history of prior visits, and thus identify the local shopping mall as a relevant absolute spatial context. In this case, the CE may output both the abstract spatial context (‘shopping mall context’) and an ID signifying an absolute spatial context.

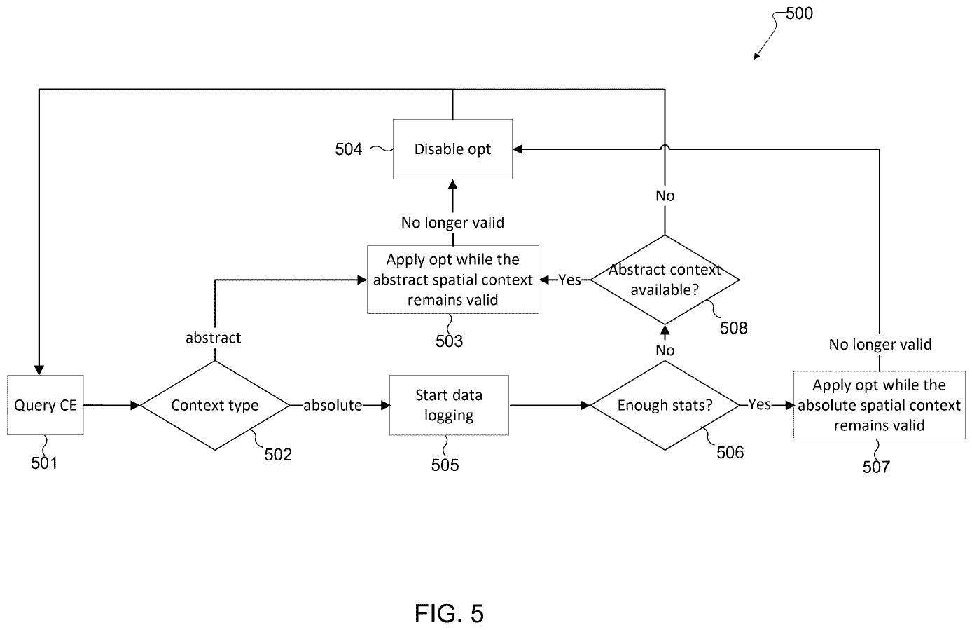

The spatial contexts may be designed for optimizing the user experience and may not directly relate to the cellular operation. However, the spatial contexts may provide information about the environment or serve as a location marker to enable location-learning for optimizing the UE performance. By leveraging the information extracted from the spatial contexts, the present disclosure provides spatial contexts-based UE performance optimization approaches in wireless communication systems. FIGS. 5-22 illustrate non-limiting embodiments of the spatial contexts-based UE performance optimization approaches, the resultant benefits, and related concepts thereof in greater detail in accordance with the present disclosure.

FIG. 5 illustrates an example process 500 for optimizing the UE performance using spatial contexts in wireless communication systems in accordance with example embodiments of the present disclosure. The example process as shown in FIG. 5 is for illustration only, and could have the same or similar configuration. One or more of the components illustrated in FIG. 5 may be implemented in specialized circuitry configured to perform the noted functions or one or more of the components may be implemented by one or more processors executing instructions to perform the noted functions. Other embodiments of the UE performance optimization using spatial contexts in accordance with the present disclosure could be used without departing from the scope of this disclosure. FIG. 5 does not limit the scope of this disclosure to any particular embodiment of the UE performance optimization using spatial contexts.

The example process 500 shown in FIG. 5 may begin at operation 501. At operation 501, the device (e.g., the UE 111-116 of FIGS. 1 and 3 and/or components thereof such as the processor 340) may query a CE for spatial contexts. At step 502, the device may determine the type of the spatial context from the CE. The usages of the two types of the spatial contexts may be different and utilized in two different branches. Note that the CE may output both types of contexts at the same time. When both types are output from the CE, a priority may be given to the absolute context. The abstract spatial contexts may provide a generic description of the environment, e.g., a private place (e.g., a home) vs. a public place (e.g., a shopping mall) with a large number of people walking around. At step 503, based on a determination the spatial context is the abstract spatial context, the device may identify and apply an optimization mode as long as the abstract spatial context remains valid. One optimization based on the abstract spatial contexts may include a selection of one or more algorithms and/or configuration parameters that may be tuned to obtain the best performance for the environment type. In this case, data may not be logged since the information is the environment type, which is the abstract spatial context. At step 504, if the abstract spatial context is no longer valid, the device may disable the optimization mode.

The absolute spatial contexts may provide unique location markers. In many cases, these absolute contexts may correspond to some physical locations where the user frequently visits and spends the most time. For example, the absolute spatial contexts of interest to the user may be the workplace of the user (e.g., further divided into multiple zones), a local grocery store, a park in the neighborhood, etc. For such unique locations, there may be no semantic interpretation that may be readily obtained in a similar manner as the abstract spatial context. For this case, location-based learning may be activated to learn to optimize the UE performance for the location. As such, if the spatial context is an absolute spatial context, at step 505, the device may begin the data logging. At step 506, the device may determine whether a sufficient amount of data has been logged (collected). At step 507, if a sufficient amount of data has been logged to derive reliable statistics for the location, the device may identify and apply an optimization mode for the location. This optimization mode may stay active while the absolute spatial context remains valid. At step 504, the device may disable the optimization mode based on a determination that the absolute spatial context is no longer valid. At step 508, if an insufficient amount of statistics (e.g., the learning for this location has just started and an insufficient amount of data has been collected) has been logged, the device may check if the abstract spatial context for this location is available. If the abstract spatial context is available, the device may identify and apply an optimization mode as long as the abstract spatial context remains valid (step 503). If the abstract spatial context is not available, the device may revert to step 501 and query the CE for the spatial context.

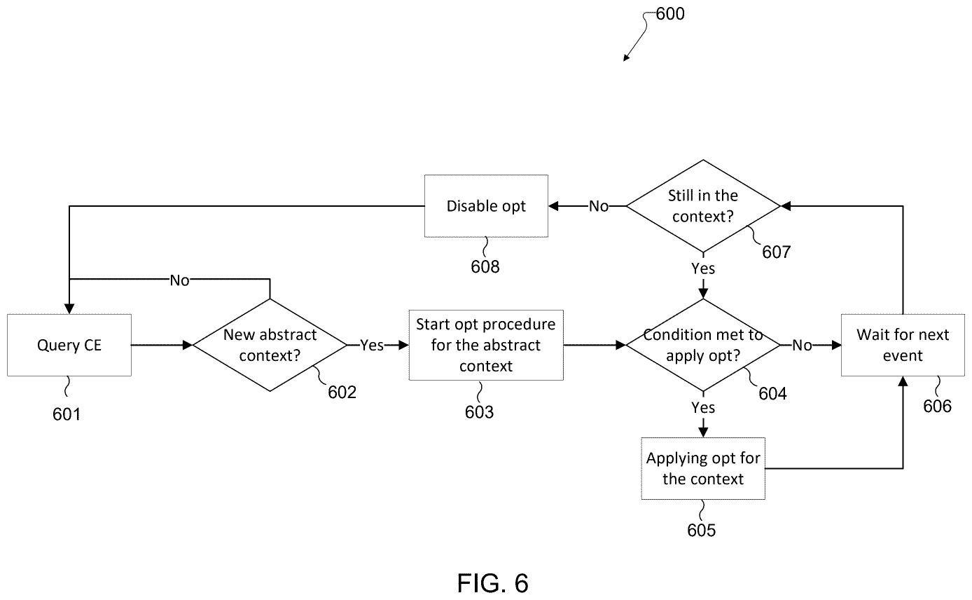

FIG. 6 illustrates an example process 600 for optimizing the UE performance using abstract spatial contexts in wireless communication systems in accordance with example embodiments of the present disclosure. The example process as shown in FIG. 6 is for illustration only, and could have the same or similar configuration. One or more of the components illustrated in FIG. 6 may be implemented in specialized circuitry configured to perform the noted functions or one or more of the components may be implemented by one or more processors executing instructions to perform the noted functions. Other embodiments of the UE performance optimization using abstract spatial contexts in accordance with the present disclosure could be used without departing from the scope of this disclosure. FIG. 6 does not limit the scope of this disclosure to any particular embodiment of the UE performance optimization using abstract spatial contexts.

As shown in FIG. 6, the process 600 may begin at step 601. At step 601, the device (e.g., the UE 111-116 of FIGS. 1 and 3 and/or components thereof such as the processor 340) may query a CE for a current spatial context. At step 602, the device may determine whether a new abstract spatial context is detected based on the CE output. At step 603, if a new abstract spatial context is detected, the device may select a corresponding optimization procedure for the new abstract spatial context and start the optimization procedure. The optimization procedure may be, e.g., a mode selection such as algorithms and/or parameters selections. At step 604, the device may determine whether a condition is met for applying the selected optimization mode. For example, depending on the abstract spatial context, additional conditions may be satisfied before the selected optimization mode may be applied.

At step 605, if the condition is met, the device may apply the selected optimization for the detected abstract spatial context. The device may remain in this optimization mode until an event of interest is detected. At step 606, if the condition is not met, the device may not apply the selected optimization and wait for a next event of interest. An event of interest may include a timeout event (i.e., checking the condition periodically with a periodicity equal to the timeout duration), changes in the applications (e.g., changes in the data traffic demand), spatial context changes (e.g., mobility or movement detected by the sensors), etc.

At step 607, if a new event of interest is detected, the device may check whether the current spatial context is still valid. At step 608, if the current spatial context is no longer valid, the device may disable the selected optimization mode and return to step 601 to query the CE and wait for detection of a new abstract spatial context. If the current spatial context remains valid, the device may revert to step 604 to determine whether a condition is still met to apply the optimization mode.

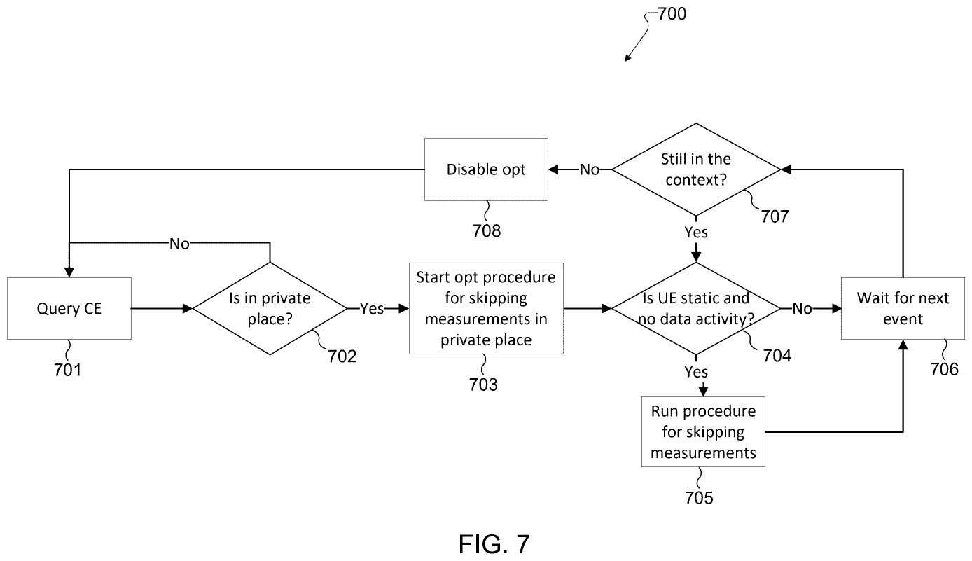

FIG. 7 illustrates an example process 700 for optimizing the UE performance using a private place context in wireless communication systems in accordance with example embodiments of the present disclosure. The examples process shown in FIG. 7 is for illustration only, and could have the same or similar configuration. One or more of the components illustrated in FIG. 7 may be implemented in specialized circuitry configured to perform the noted functions or one or more of the components may be implemented by one or more processors executing instructions to perform the noted functions. Other embodiments of the UE performance optimization using abstract spatial contexts in accordance with the present disclosure could be used without departing from the scope of this disclosure. FIG. 7 does not limit the scope of this disclosure to any particular embodiment of the UE performance optimization using abstract spatial contexts.

The CE may detect different abstract spatial contexts that may be used for the UE performance optimization. One such context may be a private place context. A private place may be defined as a home or office room where the user stays and may have few or no other people around for most of the time. In this abstract spatial context, the environment may be mostly static, which translates to a stable channel or signal quality. This may mean radio resource measurements (RRM) may be reduced to save the UE power without affecting the UE performance. Such a procedure for power saving in a private place context is illustrated in FIG. 7.

As shown in FIG. 7, the process 700 may begin at step 701. At step 701, the device (e.g., the UE 111-116 of FIGS. 1 and 3 and/or components thereof such as the processor 340) may query the CE for a current spatial context. At step 702, the device may determine whether the current spatial context detected is in a private place (i.e., a private place context). At step 703, if the abstract spatial context is the private place context, the device may start an optimization procedure for skipping RRMs in the private place. If the abstract spatial context is the private place context, the selected optimization procedure may include skipping some RRMs.

At step 704, the device may check for conditions suitable for RRM skipping. Such a condition may be that the UE is static and there is no data activity (i.e., the UE is in the connected state without data, or it is in idle or inactive state). Since the surrounding environment has little movement, the channel may be expected to have little to no change when the UE is static, and thus frequent RRMs may be wasteful.

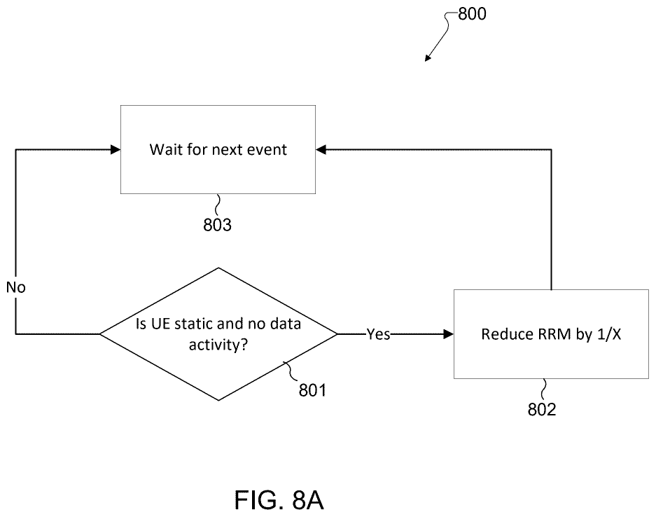

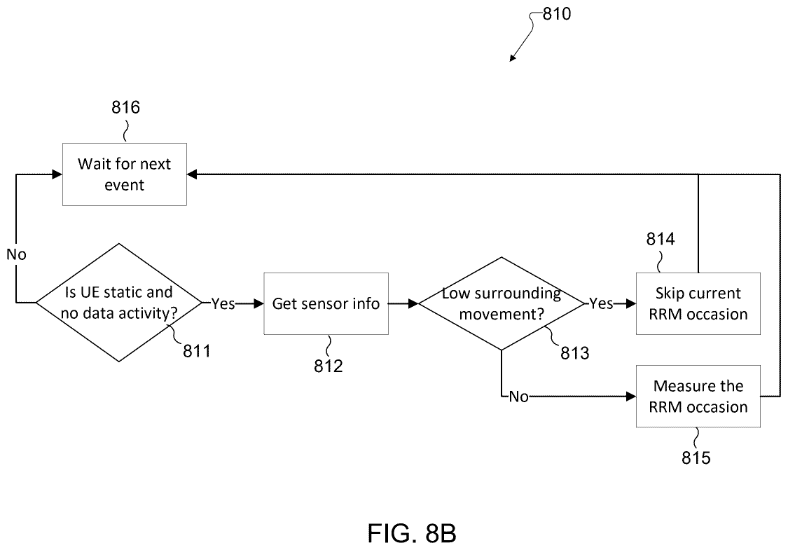

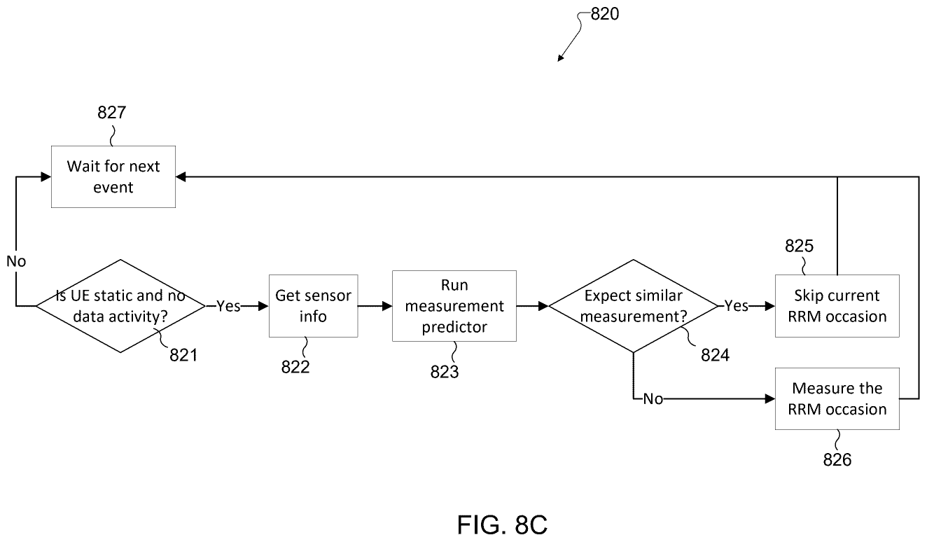

At step 705, if the UE remains static and there is no data activity, the optimization mode for RRM reduction may be performed. Examples of the RRM reduction are discussed further in detail with reference to FIGS. 8A-C. At step 706, if the UE does not remain static and/or there is data activity, the device may wait for a next event of interest. At step 707, the device may determine whether the abstract spatial context remains valid upon a detection of a next event of interest. If yes, the device may revert to step 704 to determine whether the UE remains static and there is no data activity. If no, at step 708 the device may disable the optimization mode and revert to step 701 to query the CE.

FIGS. 8A-C illustrate example processes 800, 810, 820 of the RRM reduction optimization mode in wireless communication systems in accordance with example embodiments of the present disclosure. The examples process shown in FIGS. 8A-C are for illustration only, and could have the same or similar configuration. One or more of the components illustrated in FIGS. 8A-C may be implemented in specialized circuitry configured to perform the noted functions or one or more of the components may be implemented by one or more processors executing instructions to perform the noted functions. Other embodiments of the RRM reduction optimization modes in accordance with the present disclosure could be used without departing from the scope of this disclosure. FIGS. 8A-C do not limit the scope of this disclosure to any particular embodiment of the RRM reduction optimization modes.

The example process 800 shown in FIG. 8A may begin at step 801 (similar to step 704 of FIG. 7). At step 801, the device may determine whether the UE is static and there is no data activity. At step 802, if the UE is static and there is no data activity, the device may reduce RRMs by 1/X. RRM measurements may be reduced by 1/X times (where X may be 2, 3, 4, etc.) as long as the UE is in the private place context. At step 803, the device may wait for a next event of interest upon reducing RRMs or determining that the UE is not static and/or there is data activity.

The example process 810 shown in FIG. 8B may begin at step 811 (similar to step 704 of FIG. 7). At step 811, the device may determine whether the UE is static and there is no data activity. At step 812, if the UE is static and there is no data activity, the device may obtain sensor information from one or more sensors associated with the UE. At step 813, an assessment module may determine whether the sensor information indicates a low surrounding movement (e.g., a surrounding movement less than a predetermined threshold). The sensor information from, e.g., light sensors, motion sensors, etc. may be utilized to detect movements in the surrounding environment. In this case, depending on the assessment using these sensors, the UE may either perform or skip the current RRM opportunity. At step 814, if there is a low surrounding movement, the device may skip a current RRM occasion. At step 815, if the surrounding movement is not low, the device may measure the current RRM occasion. For example, if there are people walking around near the device (potentially causing body shadowing effect), then the channel quality may be affected, warranting an RRM. At step 816, the device may wait for a next event of interest upon a determination that the UE is not static and/or there is data activity, a measurement of a current RRM occasion, or skipping of the current RRM occasion.

The example process 820 shown in FIG. 8C may begin at step 821 (similar to step 704 of FIG. 7). At step 821, the device may determine whether the UE is static and there is no data activity. At step 822, if the UE is static and there is no data activity, the device may obtain sensor information from one or more sensors associated with the UE. At step 823, the device may run a measurement predictor to determine whether a next RRM occasion may be skipped. The measurement predictor may obtain sensor information (e.g., light, IMU, etc.) and past cellular measurements as its input to predict if there is a substantial change in the signal. For example, the measurement predictor may be a classifier that performs measurement predictions if the link quality changes (up or down) or drop (down only) by a threshold such as 10 dB. At step 824, it is determined whether a similar measurement is expected for a current RRM occasion based on the predictor's output. At step 825, if a similar measurement is expected, the device may skip the current RRM occasion. At step 826, if a similar measurement is not expected, the device may measure the current RRM occasion. At step 827, the device may wait for a next event of interest upon a determination that the UE is not static and/or there is data activity, a measurement of a current RRM occasion, or skipping of the current RRM occasion.

For the example processes 810 and 820, in order to prevent the impact of failure of the assessment module or the measurement predictor module, a safeguard rule may be utilized to set the minimum level of RRM that the UE may perform regardless of the output from those modules. For example, the UE may be set to not skip more than five consecutive measurement opportunities in a row. In this case, if the UE has skipped five consecutive measurement opportunities already, at the sixth measurement opportunity, even if the output from the assessment module or the predictor is to skip, the UE may perform the measurement regardless.

In another embodiment, an additional safeguard mechanism may be introduced to avoid the case where the determination to skip the measurements may be erroneous. This may be due to sudden changes in the environment or simply the CE erroneously outputting an incorrect spatial context. In one implementation, the expected signal quality may be compared against the measurements when available. The expected signal quality may be just the past available measurements or some prediction from past measurements by averaging or running some autoregressive algorithms. For the embodiments in FIGS. 8A-B, the device may only use past measurements. For the embodiment in FIG. 8C, the determination may be based on past measurements or a comparison of the prediction results to the actual measurements. For example, if the prediction is off by 5 or 10 dB, the prediction may be considered incorrect. With either method, the occurrences of incorrect predictions may be counted and when the number of incorrect predictions (this may be counted within a time window) exceeds some threshold, the context may be declared to have a low confidence, and the optimization may be disabled for a timeout duration or for this session while in this spatial context.

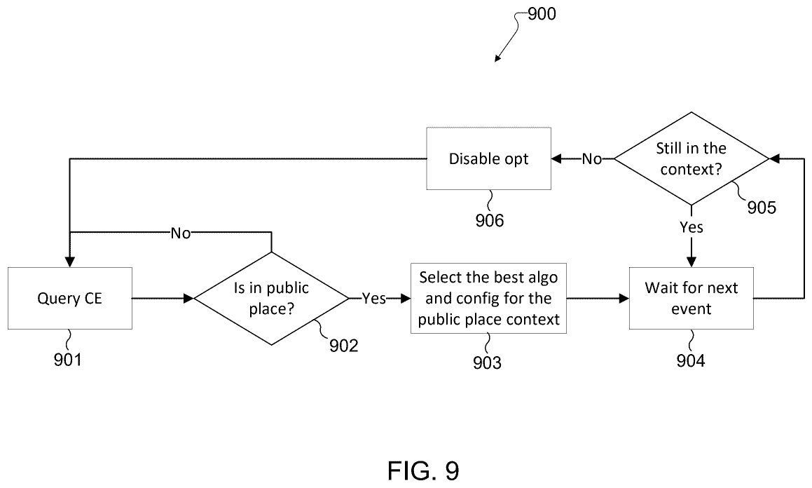

FIG. 9 illustrates an example process 900 for optimizing the UE performance using a public space context in wireless communication systems in accordance with example embodiments of the present disclosure. The example process shown in FIG. 9 is for illustration only, and could have the same or similar configuration. One or more of the components illustrated in FIG. 9 may be implemented in specialized circuitry configured to perform the noted functions or one or more of the components may be implemented by one or more processors executing instructions to perform the noted functions. Other embodiments of the UE performance optimization using a public space context in accordance with the present disclosure could be used without departing from the scope of this disclosure. FIG. 9 does not limit the scope of this disclosure to any particular embodiment of the UE performance optimization using a public space context.

In one embodiment, the CE may detect a ‘public place’ as another abstract spatial context. A public place may be defined as a location where there are a large number of people around such as an airport, a stadium, a theater, a shopping mall, etc. The public place context may be further divided into two subtypes:
Public place with static users: for example, a theater or a cinema where most users may be sitting or staying at their seats.
Public place with moving users: for example, shopping malls, or airport where many users may be moving around in the space.
   The public place context may have the following impacts on the cellular link/network condition:
Many users moving around may cause frequent body shadowing effects unique to such public place context, especially the public place with moving users.
Due to the high density of users, there may be limited resources and a high interference level that the UE may expect.

One way to optimize based on this context may be to fine-tune the communication algorithms and configuration parameters to best suit for the above two properties. The fine-tuning may be performed offline by collecting wireless channels for locations where the ‘public place’ was detected. The collected data may then be used to fine-tune the algorithms and/or refine choices of the configuration parameters that work best for the level of temporal variation (e.g., due to the frequent body shadowing), congestion and interference level. For example, channel estimation and prediction algorithms may be tuned to best leverage the temporal correlation of channel variations due to the body shadowing effects. Similarly, the configuration parameters may be selected to provide the most robust performance against the potential congestion and interference expected from the high density of the users. Further as described above, if subtypes of ‘public place’ are available, fine-tuning may be performed for each subtype separately.

The example process 900 utilizing the public place context as shown in FIG. 9 may begin at step 901. At step 901, the device (e.g., the UE 111-116 of FIGS. 1 and 3 and/or components thereof such as the processor 340) may query the CE for a current spatial context. At step 902, the device may determine whether the current spatial context detected is in a public place (i.e., a public place context). At step 903, the device may select the best algorithm and configuration parameters for the public place context. Since the algorithms and configuration parameters may be tuned for the environment, these choices may be activated when the public place context is detected. At step 904, upon activating the best algorithm and configuration parameters, the device may monitor for a next event of interest, which in this case may include a change in the context and/or performance degradation.

At step 905, the device may determine whether the public context remains valid. For example, the performance degradation may be due to the CE incorrectly detecting the ‘public place’ when in fact the UE is not in such a place or due to a mismatch between a public place and what the UE is actually experiencing. In either case, the public place context may be deemed invalid. At step 906, if the public context is no longer valid, the device may disable the optimization (the selected best algorithm and configuration parameters) and revert to step 901 to query the CE and wait for a new context.

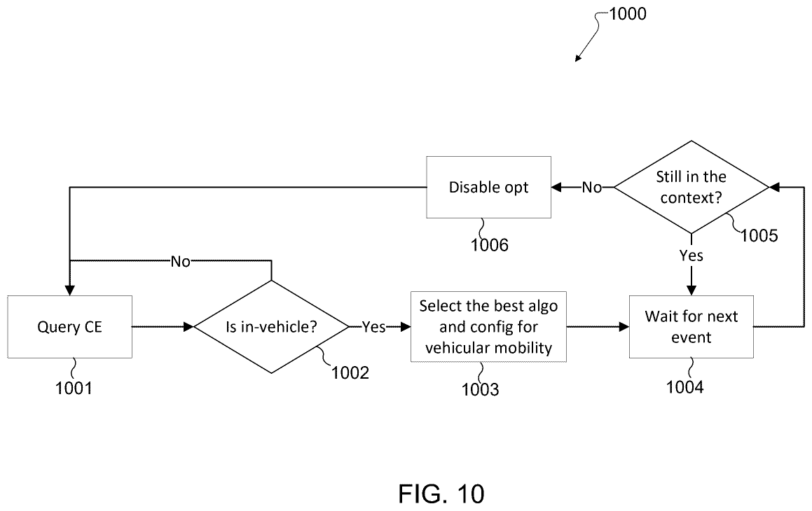

FIG. 10 illustrates an example process 1000 for optimizing the UE performance using an in-vehicle context in wireless communication systems in accordance with example embodiments of the present disclosure. The example process shown in FIG. 10 is for illustration only, and could have the same or similar configuration. One or more of the components illustrated in FIG. 10 may be implemented in specialized circuitry configured to perform the noted functions or one or more of the components may be implemented by one or more processors executing instructions to perform the noted functions. Other embodiments of the UE performance optimization using an in-vehicle context in accordance with the present disclosure could be used without departing from the scope of this disclosure. FIG. 10 does not limit the scope of this disclosure to any particular embodiment of the UE performance optimization using an in-vehicle context.

In one embodiment, the CE may detect an ‘in-vehicle’ context as another abstract spatial context for optimizing the UE. ‘In-vehicle’ may mean in a private vehicle (as a driver or passenger) or in a public bus or train. Depending on the subtypes that the CE can detect, the optimization specific to each subtype may be performed similarly to the optimization for the public place context. In all of these cases, a common property of this context may be the high mobility (vehicular speed).

The example process 1000 shown in FIG. 10 may begin at step 1001. At step 1001, the device (e.g., the UE 111-116 of FIGS. 1 and 3 and/or components thereof such as the processor 340) may query the CE for a current spatial context. At step 1002, the device may determine whether the current spatial context detected is an in-vehicle context. At step 1003, the device may select the best algorithm and configuration parameters for the vehicular mobility. If the subtypes may be differentiated, the channels and/or signal collected for each subtype may be utilized to refine the choices for each subtype. For example, in a public transportation setting, in addition to the high mobility, there may be many other users in the same vehicle that may place an additional constraint on the resources and interference level. At step 1004, upon activating the best algorithm and configuration parameters, the device may monitor for a next event of interest. At step 1005, the device may determine whether the in-vehicle context remains valid. At step 1006, if the in-vehicle context is no longer valid, the device may disable the optimization (the selected best algorithm and configuration parameters) and revert to step 1001 to query the CE and wait for a new context.

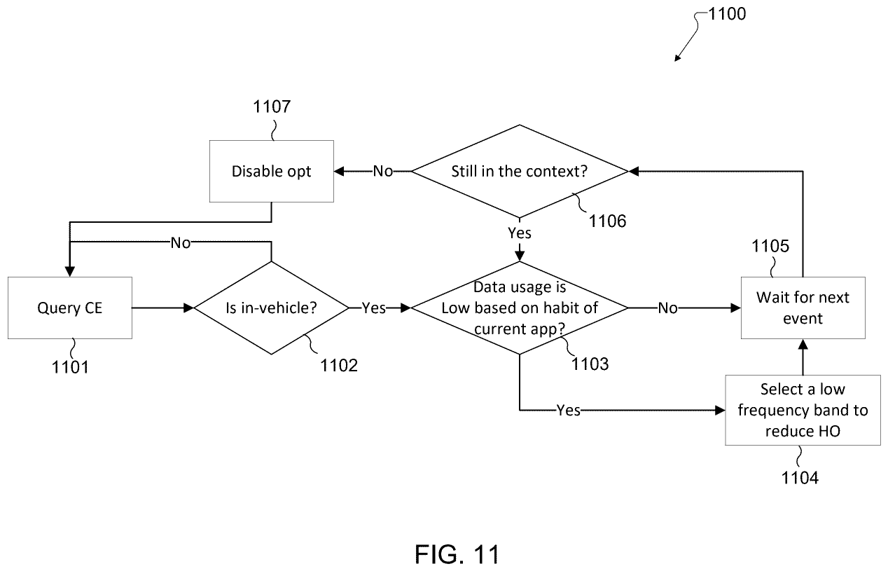

FIG. 11 illustrates an example process 1100 for optimizing the UE performance using an in-vehicle context in wireless communication systems in accordance with example embodiments of the present disclosure. The examples process shown in FIG. 11 is for illustration only, and could have the same or similar configuration. One or more of the components illustrated in FIG. 11 may be implemented in specialized circuitry configured to perform the noted functions or one or more of the components may be implemented by one or more processors executing instructions to perform the noted functions. Other embodiments of the UE performance optimization using an in-vehicle context in accordance with the present disclosure could be used without departing from the scope of this disclosure. FIG. 11 does not limit the scope of this disclosure to any particular embodiment of the UE performance optimization using an in-vehicle context.

Another optimization that may be useful for an in-vehicle context may be the reduction of the handover (HO) cost. The example process 1100 utilizing the HO cost reduction as shown in FIG. 11 may begin at step 1101. At step 1101, the device (e.g., the UE 111-116 of FIGS. 1 and 3 and/or components thereof such as the processor 340) may query the CE for a current spatial context. At step 1102, the device may determine whether the current spatial context detected is an in-vehicle context. At step 1103, the device may check whether the data usage is low (e.g., the data usage is less than a predetermined threshold). In one implementation, the data usage may be based on past habit of the user. For example, a user may only stream audio while in-vehicle and thus utilize data at only low data rate, whereas another user may stream a music video which has relatively high data rate. In another implementation, there may be an on-device learning mechanism that may track the data usage demand for each application. In that case, if the currently active application corresponds to an application with a low data rate demand based on the on-device learning mechanism, then it may be deemed to be in a low data rate demand state.

At step 1104, if it is determined that the data rate demand is low, the UE may switch to a low frequency band (if such a band is known to be available in the area) to reduce a number of HOs. At step 1105, the device may wait for a next event of interest upon selecting the low frequency band or based on a determination that the data usage is low. As an additional safeguard to avoid potential QoE degradation, surges in data demand may be detected as an event of interest. At step 1106, upon detection of the next event of interest, the device may determine whether the in-vehicle context is still valid. At step 1107, if the in-vehicle context is no longer valid, the device may disable the optimization (e.g., deactivate the policy to use the low frequency band to reduce HO) and revert to step 1101 to query the CE.

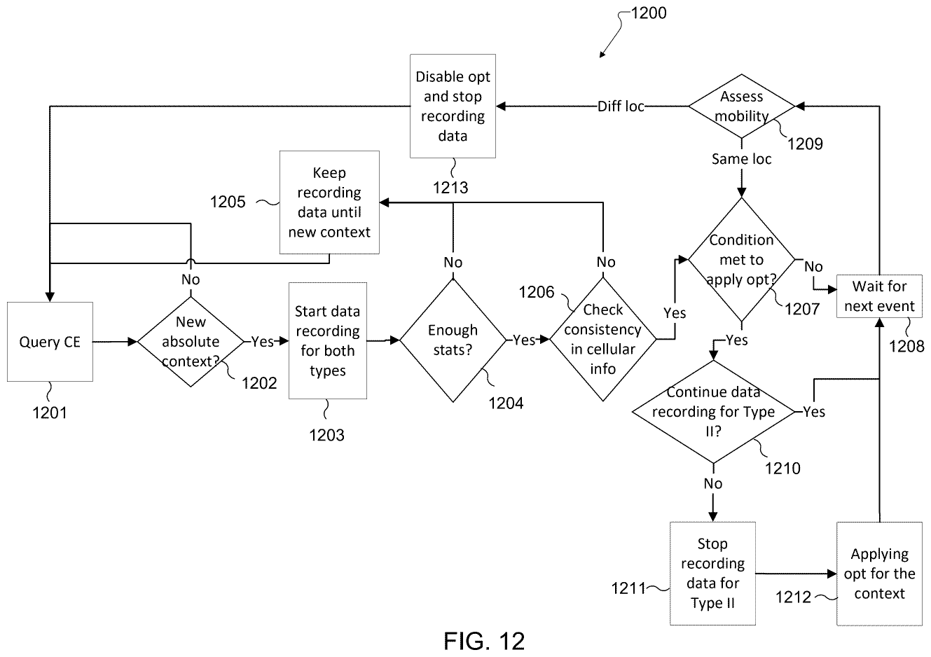

FIG. 12 illustrates an example process 1200 for optimizing the UE performance using absolute spatial contexts in wireless communication systems in accordance with example embodiments of the present disclosure. The example process shown in FIG. 12 is for illustration only, and could have the same or similar configuration. One or more of the components illustrated in FIG. 12 may be implemented in specialized circuitry configured to perform the noted functions or one or more of the components may be implemented by one or more processors executing instructions to perform the noted functions. Other embodiments of the UE performance optimization using absolute spatial contexts in accordance with the present disclosure could be used without departing from the scope of this disclosure. FIG. 12 does not limit the scope of this disclosure to any particular embodiment of the UE performance optimization using absolute spatial contexts.

Absolute spatial contexts may provide unique location markers that may be utilized for optimizing the UE performance by adapting to the NW conditions and/or capabilities at the locations. As the absolute spatial context may only inform the location of the UE, it may not have any information about the NW conditions and/or capabilities. As such, the on-device learning component may be utilized. Using the on-device learning component, the UE may learn to optimize specific target configurations or parameters by collecting data for relevant parameters. Further, there may be design choices to fit the properties of a CE where:
CE may misidentify an absolute spatial context: The severity may depend on both the CE solution as well as the environment in which the user is (some environments may be more challenging than others).
CE may have latency before detecting a spatial context: A CE may utilize various sources of information in a passive manner in order to minimize the resource consumption. For example, if the CE utilizes WiFi® information (e.g., surrounding Access Points or APs that the UE can see as well as their corresponding signal strengths), it may wait for the scans to happen naturally, which can take some time especially if it needs to observe a sufficient number of neighboring APs. Examples of such latency may be on the order of a few to 10 s of seconds.

Recording data (or data collection) for each absolute spatial context may be essential for this optimization. In this disclosure, the data collection may serve two main purposes:
Data collection for the target optimization.
Data collection for spatial context verification.
   The data collection for target optimization may focus on physical parameters and configurations that tend to have dependence on the spatial location and offer opportunities for optimization. One example may be the number of MIMO (Multiple Input Multiple Output) layers. From theory, spatial multiplexing (i.e., using a higher number of MIMO layers) may be better when the channel is rich in scattering with a sufficiently high signal strength. On the contrary, if the channel is not rich and the channel is not weak, a single stream may provide a better performance than multiple streams and fewer antennas may be more power efficient with a negligible loss in performance. Thus, depending on the environments, some locations may not be able to support and/or efficiently operate a high number of MIMO layers. In those locations, some antennas may be turned off to save some power without losing any throughput. Similarly, if the location only has 4G RAT (radio access technology) coverage, there may be no need to monitor or perform measurements to search for 5G RAT while in the location. Other types of metrics may help identify some properties of the environments such as the level of temporal variation and interference. Further, there may be some events of interest such as failure events where the failure event may be recorded along with some information or network configuration at the time of the failure such as the frequency band ID and the cell ID.

For the location verification purposes, a cell ID, a frequency band, and the signal strengths (e.g., the Reference Signal Receive Power or RSRP, Received Signal Strength Indicator or RSSI, etc.) may act as a fingerprint-like identifier that may be established for the location during the learning stage. Once a sufficient amount of measurements has been collected, the cellular measurements (including related configuration and signal strength) seen in the current session may be compared against the past data collected so far. If the cellular measurements are within the normal range of variation against the collected data, it may be determined that the cellular measurements are consistent for the location. Otherwise, the cellular measurements are not consistent for the location, and the detected spatial context may be incorrect. Note that this inconsistency may also be due to changes in the NW environment, such as a construction of a large structure (e.g., a building) that may affect the link condition and/or changes in the NW installation where base stations may be relocated, or new ones may be erected. Regardless, when inconsistency is detected, it may be risky to apply the optimization.

For the data recording, there may be two separate processes depending on the properties of the target metrics: a process for Type I metrics and a process for Type II metrics. Type I metrics may be the metrics not affected by the applied optimization, while Type II metrics may be those that are affected. For example, if the optimization is the selection of the number of MIMO layers for the location, and in that location past data suggests the environment can only support two layers MIMO. In this case, when the optimization is applied, the maximum number of the MIMO layers may be two, and even if there is a change in the NW or environment and that now four layers of MIMO can be supported, only two MIMO layers may be seen as the maximum, which is incorrect. Thus, in this case the number of MIMO layers may be a Type II metric. To summarize, based on this definition of Type I and Type II, it may imply:
For Type I metrics, data recording may be performed the entire time when the UE is in the absolute spatial context and the metric is available.
For Type II metrics, data recording may be performed when the UE is in the absolute spatial context, and the optimization is NOT applied.

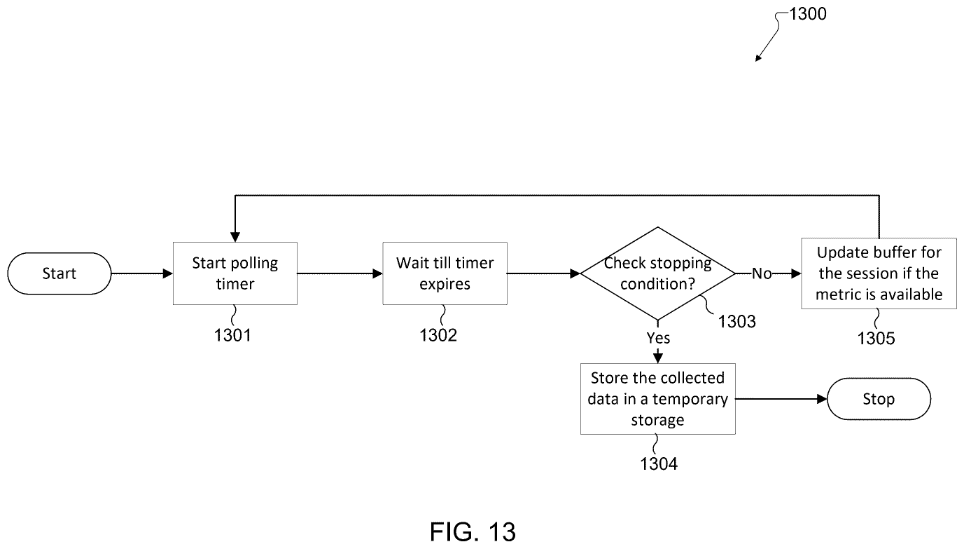

The example process 1200 utilizing the absolute spatial contexts as shown in FIG. 12 may begin at step 1201. At step 1201, the device (e.g., the UE 111-116 of FIGS. 1 and 3 and/or components thereof such as the processor 340) may query the CE for a current spatial context. At step 1202, the device may determine whether the current spatial context detected is a new absolute context. At step 1203, upon detection of a new absolute context, the device may start data recording for both the Type I data type and the Type II data type. Note that depending on the metrics they may not be always available. For example, some metrics may be only available while in the connected state and some metrics may further require that applications with high enough data rate are being used. An example process of data recording is illustrated in FIG. 13.

At step 1204, the device may determine whether a sufficient amount of data (e.g., statistics) have been collected. At step 1205, if there are insufficient statistics, the device may continue the data recording while in the spatial context. If there are insufficient statistics (i.e., an insufficient amount of data has been collected in the spatial context), it may mean that an insufficient amount of learning (e.g., for an on-device learning component) has been performed at the spatial location.

At step 1206, if there are sufficient statistics, then the device may check the consistency of the cellular information for this absolute spatial context. This step may aim at reducing potential misidentification of the spatial context by the CE, and also serve as a safeguard mechanism for detecting potential changes in the NW environment that may render the learned information so far outdated. If the current cellular information is not consistent with past data at the spatial context, then regardless of which of the two possible causes (an incorrect spatial context output from the CE or a change in the NW environment), it may mean that the learned information so far is likely not applicable. In this case, the device may continue logging the data without applying any optimization (step 1205). The data for the session may be recorded in a temporary storage, which may be used to update the learned information for the spatial context or discarded. For example, if subsequent data in future visits to the spatial context are consistent, it may be likely that there were some changes in the NW environment, and thus this may be used to update the information for the spatial context. If the cellular information at the spatial context is not consistent in future visits to the spatial context, then it may be likely that this was a one-off error case due to an incorrect spatial context detection, and thus may be discarded.

At step 1207, if the cellular information is consistent, the device may continue to check conditions for applying the optimization. This may depend on the applications. At step 1208, if the condition is not met, the device may wait for a next event of interest, and at step 1209, the device may assess the mobility by rechecking if the spatial context is still valid. If the spatial context is still valid, the device may recheck the condition (step 1207).

At step 1212, if the condition for applying optimization is met, the device may apply the optimization for the absolute spatial context. However, at step 1210, before applying the optimization, the device may determine whether to continue recording for Type II metrics. If the device is to continue to record the Type II metrics, the device may wait for a next event of interest (step 1208). At step 1211, if the device is not to continue to record for the Type II metrics, the device may stop recording data for the Type II metrics. This is because the Type II metrics may no longer be valid when the optimization becomes active. Upon stopping the recording for the Type II metrics, the device may apply the optimization (step 1212). Upon applying the optimization, the device may wait for a next event of interest (step 1208) and recheck the validity of the spatial context (step 1209). At step 1213, if the spatial context is no longer valid, the device may stop the data recording for both data types and disable the optimization. Note that depending on the optimization type, it may wait for an appropriate timing to disable the optimization and avoid disruption to the user.

FIG. 13 illustrates an example process 1300 for data recording for on-device learning using absolute spatial contexts in wireless communication systems in accordance with example embodiments of the present disclosure. The examples process shown in FIG. 13 is for illustration only, and could have the same or similar configuration. One or more of the components illustrated in FIG. 13 may be implemented in specialized circuitry configured to perform the noted functions or one or more of the components may be implemented by one or more processors executing instructions to perform the noted functions. Other embodiments of the data recording for the on-device learning in accordance with the present disclosure could be used without departing from the scope of this disclosure. FIG. 13 does not limit the scope of this disclosure to any particular embodiment of the data recording for on-device learning.

The data recording may be performed at a low or negligible cost by periodically (e.g., every 0.5 sec or 1 sec) reading from existing buffers of various metrics of interest by, e.g., using a polling timer mechanism. The example process 1300 for data recording using a polling timer as shown in FIG. 13 may begin at step 1301. At step 1301, the device (e.g., the UE 111-116 of FIGS. 1 and 3 and/or components thereof such as the processor 340) may start a polling timer. Most, if not all, of the metrics of interest (e.g., signal strengths such as RSRP, cell and band info, MIMO layers, data throughput at various layers, etc.) may be basic operating parameters that are already in use in the current system. Thus, the device may read data from the appropriate buffers and record the metrics of interest in the temporary buffers. The data type of the metrics of the interest may be divided into two types:
Real-valued metrics: These may include, e.g., RSRP, SINR, etc. While these metrics may be quantified, they may have a large set of possible values, and thus it may be more efficient to treat them as real-valued. For such data type, two variables for each metric may be utilized: one for the average and one to capture the variation level such as the standard deviation.
Discrete-valued metrics: These may include, e.g., a number of MIMO layers, RAT, etc. These may ingest a few possible values. For these, the occurrences for each value may be counted to approximate a probability mass function (PMF). For example, for the number of MIMO layers, the number of slots or radio frames where each number of MIMO layers was utilized may be counted. Then, by dividing by the total count of transmit or receive slots or radio frames, a PMF for the session may be estimated.

At step 1302, the device may wait until the polling timer expires. At step 1303, the device may check whether a stopping condition is met. That is, at each polling timer expiry, the stopping condition may be checked. For Type I metrics, the data recording may continue as long as the UE is still in the spatial context. For Type II metrics, even if the UE is still in the spatial context, if the optimization has been applied, then the metrics may be no longer valid, and the data recording may be stopped.

At step 1304, if the stopping condition is met, the device may store the collected data in a temporary storage. At step 1305, if the stopping condition is not met, the device may update the buffers for the current session if the metric of interest is available.

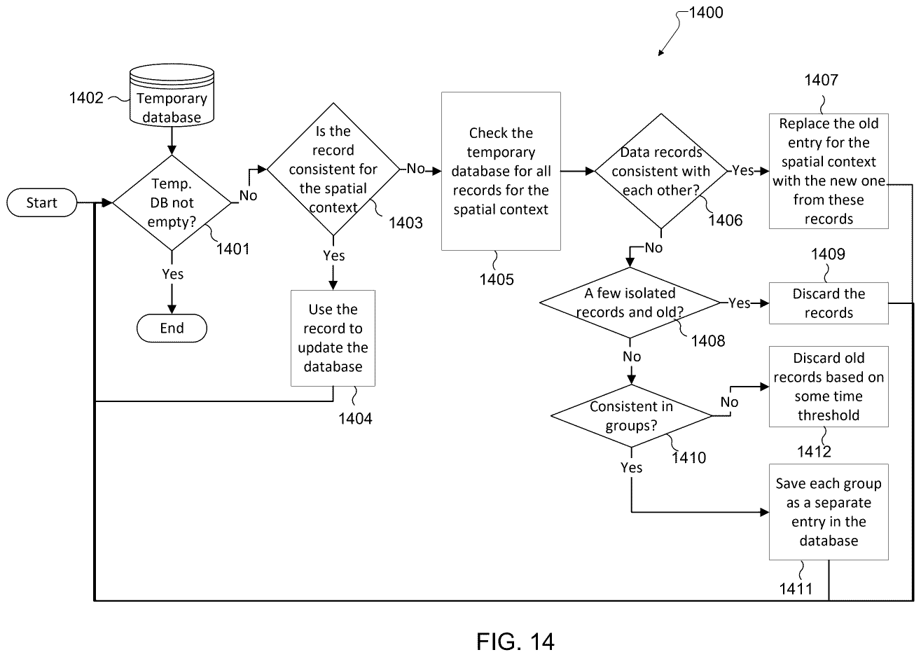

FIG. 14 illustrates an example process 1400 for updating the on-device learning component for UE performance optimization in wireless communication systems in accordance with example embodiments of the present disclosure. The examples process shown in FIG. 14 is for illustration only, and could have the same or similar configuration. One or more of the components illustrated in FIG. 14 may be implemented in specialized circuitry configured to perform the noted functions or one or more of the components may be implemented by one or more processors executing instructions to perform the noted functions. Other embodiments of the data recording for the on-device learning in accordance with the present disclosure could be used without departing from the scope of this disclosure. FIG. 14 does not limit the scope of this disclosure to any particular embodiment of updating the on-device learning component.

A significant part of the data collection task (e.g., step 1203 of FIG. 12) may be a procedure for updating the learned database using the data recorded for each session in a given absolute spatial context. This procedure may be performed after each data session or in a bulk update (including multiple records from multiple sessions collected over a period of time) that may be executed when there is a low load on the device (e.g., the device in the idle state, not in use (e.g., overnight), or being charged). This procedure may be executed for each data record to be updated into the learned database.

The example process 1400 for updating the on-device learning component as shown in FIG. 14 may begin at step 1401. At step 1401, the device (e.g., the UE 111-116 of FIGS. 1 and 3 and/or components thereof such as the processor 340) may determine whether a temporary database 1402 is empty. At step 1403, if the temporary database 1402 is not empty, the device may determine whether the recorded data in the database is consistent for the spatial context. For example, the device may determine that the recorded data is cellular information that is consistent with the existing information in the on-device learning component (a learned database) for the absolute spatial context.

At step 1404, if the recorded data is consistent, then the device may update the learned database. Thus, the recorded data may be incorporated into the learned database as a routine maintenance to update the learned database. If the recorded data is not consistent with the existing information in the learned database, it may mean that the CE may have detected an incorrect spatial context or a change in the NW environment may have occurred. Thus, the device may take steps to isolate the root causes of the inconsistency and utilize the recorded data as much as possible.

At step 1405, if the recorded data is not consistent with the exiting information in the learned database, the device may retrieve all of the data records for the absolute spatial context in the temporary database 1402.

At step 1406, the device may determine whether all of the data records are consistent with one another. Note for defining consistency here, the number of data records may be sufficiently large. At step 1407, if all of the data records are consistent, the device may replace the old entry for the absolute spatial context with the new entry from these data records. That is, if all of the data records are consistent to one another, this may likely be a case in which there may have been a change in the NW environment, and thus the device may update the learned database to replace the old entry with the new entry for the spatial context.

At step 1408, if all of the data records are not consistent with each other (including the case where the number of data records may be too small), the device may check whether these are a few isolated records and with old timestamps. If the inconsistent data records constitute a few isolated records and with old timestamps, this may likely be due to the isolated cases where the CE may have detected incorrect spatial contexts. At step 1409, if the inconsistent data records are a few isolated records (i.e., not repeatable), the device may discard the inconsistent data records since they may not be useful.

At step 1410, if there are a large number of inconsistent data records, the device may determine whether the inconsistent data records may be grouped into a few clusters (e.g., 2 or 3 clusters), where the grouped data records may be consistent with each other within each group or cluster. This may be a situation where the CE may have confused between a few absolute spatial contexts. Since this situation may be repeatable, the data may be still useful. At step 1411, the device may save these groups as separate entries in the learned database with the same spatial context ID. When the spatial context has multiple entries, the consistency check may be performed against each entry, and the optimization may be executed using the information corresponding to the entry where the current data is consistent. If the inconsistent data records do not form clear groups (e.g., they are quite spread out), this may not be a repeatable situation. At step 1412, the device may discard (delete) the old records based on a time threshold. Newer records may still be relevant, and thus may be maintained in the temporary database and processed using this same procedure at a later time. The newer records may be discarded when they become old.

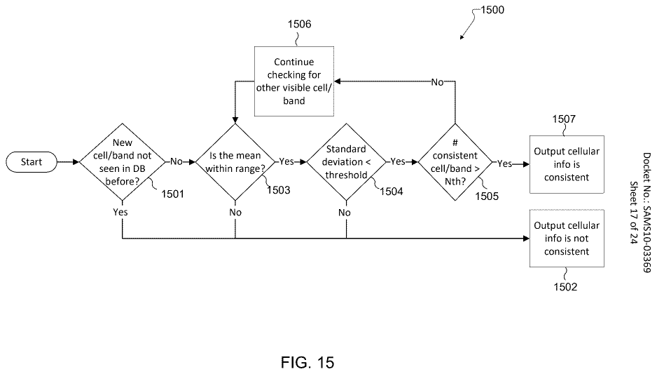

FIG. 15 illustrates an example process 1500 for determining consistency of cellular information in a spatial context in wireless communication systems in accordance with example embodiments of the present disclosure. The examples process shown in FIG. 15 is for illustration only, and could have the same or similar configuration. One or more of the components illustrated in FIG. 15 may be implemented in specialized circuitry configured to perform the noted functions or one or more of the components may be implemented by one or more processors executing instructions to perform the noted functions. Other embodiments of the cellular information consistency determination in accordance with the present disclosure could be used without departing from the scope of this disclosure. FIG. 15 does not limit the scope of this disclosure to any particular embodiment of the cellular information consistency determination.

In one embodiment, the consistency may be based on the measurements. The cellular information may be divided into those related to measurements (e.g., RSRP) and those related to configuration information (e.g., cell ID, band ID, their priority, etc.). In particular, the measurements in a cell and band (also referred to as a cell and band combination) may be compared to the information in the learned database.

In one embodiment, the configuration such as the visible cells and/or bands and their (reselection) priorities may also be utilized. For example, if there is a new cell and band that has not been recorded in the learned database, it may be likely that there is some change in the NW (e.g., some update at the base stations). In such a case, the cellular information may be deemed not consistent with the learned database for the spatial context.

The example process 1500 for determining consistency of the cellular information in a spatial context as shown in FIG. 15 may begin at step 1501. At step 1501, the device (e.g., the UE 111-116 of FIGS. 1 and 3 and/or components thereof such as the processor 340) may determine whether a new cell and band has been seen in the learned database previously. At step 1502, if the new cell and band combination has not been seen previously, the device may output that the cellular measurement is not consistent.

At step 1503, if the new cell and band combination has been previously seen, the device may determine whether the average (or mean) measurement such as the RSRP of the cell/band is within a range from the database record for the cell/band in this absolute spatial context. The range may be defined as within the plus or minus one standard deviation from the mean in the database or some variation thereof based on the desired tolerance. If the average measurement is not within the range, the device may output that the cellular measurement is not consistent (step 1502).

At step 1504, the average measurement is within the range, the device may determine whether the standard deviation of the current set of measurements is less than a threshold. For example, the device may determine if the standard deviation of the current set of measurements is of a similar or smaller value than the standard deviation of the measurements in the database. If the standard deviation is not less than the threshold, the device may output that the cellular measurements is not consistent (step 1502).

At step 1505, if the standard deviation is less than the threshold, the device may determine whether a number of consistent cell and band combinations is greater than a threshold (e.g., Nth where Nth may be set to 3 or 5, etc.). At step 1506, if the number of consistent cell and band combinations is not greater than the threshold, the device may continue checking for other visible cell and band combinations. At step 1507, if the number of consistent cell and band combinations is greater than the threshold, the device may output that the current set of measurements are consistent for the absolute spatial context.

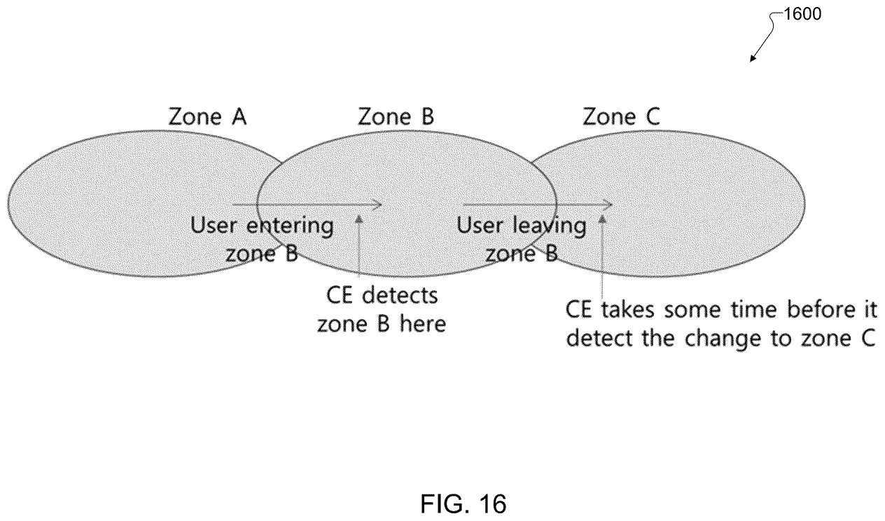

FIG. 16 illustrates an example diagram 1600 depicting CE latency in detecting spatial contexts in wireless communication systems in accordance with example embodiments of the present disclosure. The examples process shown in FIG. 16 is for illustration only, and could have the same or similar configuration. One or more of the components illustrated in FIG. 16 may be implemented in specialized circuitry configured to perform the noted functions or one or more of the components may be implemented by one or more processors executing instructions to perform the noted functions. Other embodiments of the CE latency in spatial contexts detection in accordance with the present disclosure could be used without departing from the scope of this disclosure. FIG. 16 does not limit the scope of this disclosure to any particular embodiment of the CE latency in spatial contexts detection.

For maximizing the utility of the spatial contexts, the latency in the context detection by a CE may be accounted. A CE may be designed to rely on passive information gathering that may take some time, and it may take 10 s of seconds before a CE can detect the spatial context in which the device is. This latency may create ambiguity in the spatial context at the boundaries between adjacent absolute spatial contexts.

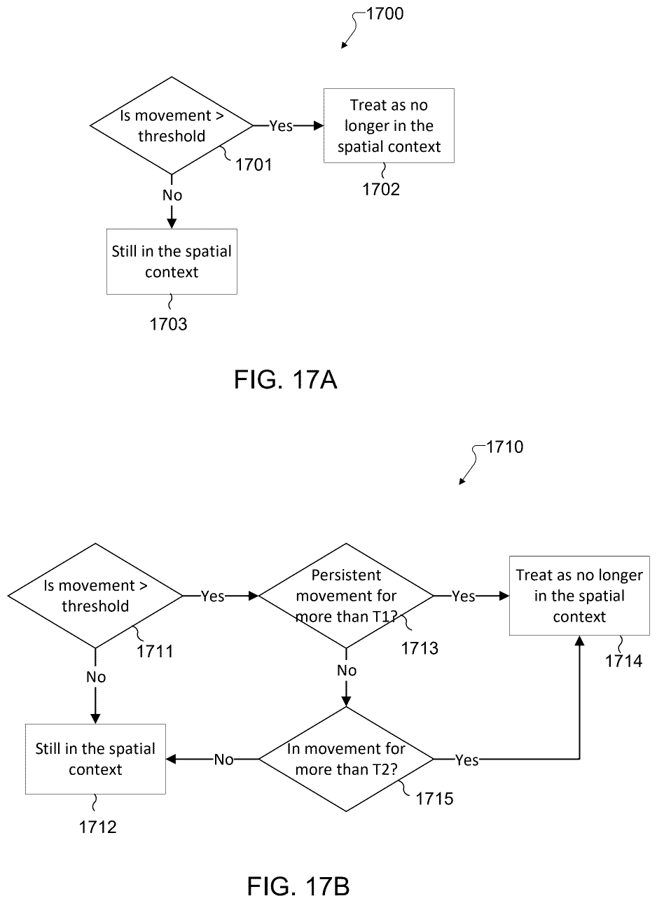

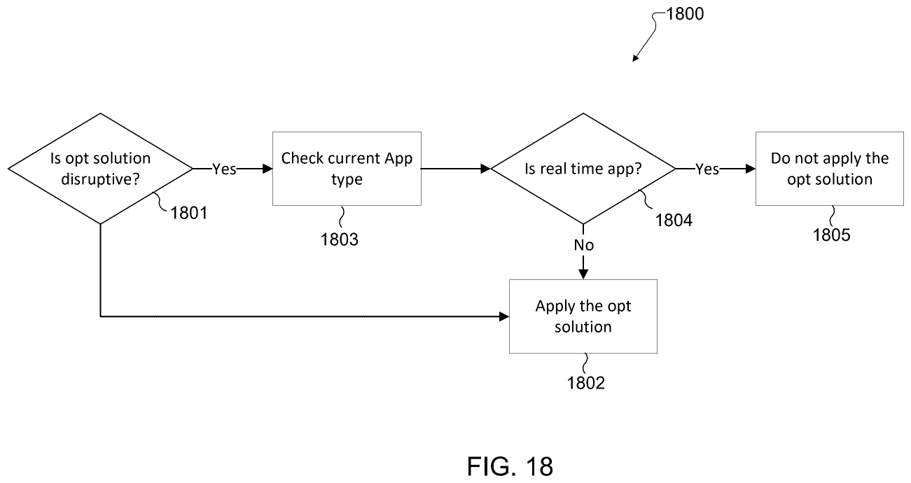

As shown in FIG. 16, a user may be moving from Zone A to Zone B, which are two adjacent absolute spatial contexts. Due to the latency of the CE, the CE may only detect Zone B after the user has already been in Zone B for some time. A similar situation may occur when the user is leaving Zone B to Zone C. The CE may fail to detect that the user is already out of Zone B for some time. The impact of the latency when the user is moving in and when the user is moving out may not be the same. For the moving-in case, it may mean there may be some delay in applying the optimization. Thus, there may be some time lost for the optimization, but the delay may not cause a degradation (as compared to the baseline existing solution). However, in this duration in which the user is already in the spatial context but before the CE detects the spatial context, the device may provide measurements that may be used for the consistency check as well as some data for updating the database (especially for Type II metrics). The moving-out case may cause some degradation if there is some mismatch between the current spatial context and the next one. Example processes for dealing with the moving-out situations are illustrated in FIGS. 17-18.

FIGS. 17A and 17B illustrate example processes 1700, 1710 for mobility assessment in wireless communication systems in accordance with example embodiments of the present disclosure. The example processes shown in FIGS. 17A-B are for illustration only, and could have the same or similar configuration. One or more of the components illustrated in FIGS. 17A-B may be implemented in specialized circuitry configured to perform the noted functions or one or more of the components may be implemented by one or more processors executing instructions to perform the noted functions. Other embodiments of the mobility assessment in accordance with the present disclosure could be used without departing from the scope of this disclosure. FIGS. 17a-B do not limit the scope of this disclosure to any particular embodiment of the mobility assessment.

For the moving-in part, the main concern may be whether the duration before the CE can detect the spatial context may be utilized to collect cellular data for consistency check and/or update the learning database. When a new spatial context is detected, the cellular information in the past T seconds may be extracted as part of the data in this newly detected spatial context. The value of T may be obtained from the property of the CE. For example, if the CE takes a minimum of 20 sec in a spatial context before it can detect the context, then T may be set to 20 sec. To enable the data extraction for the past T seconds, the cellular modem having some temporary buffers that can store the metrics of interest in the recent past may only be utilized.

For the moving out part, in order to safeguard against a potentially negative impact, the moving out event may need to be detected prior to when the user is out of the spatial context. In the example process 1700 of FIG. 17A, the application of the optimization may be limited to when the user is static in the spatial context. In this case, the optimization may be disabled when a movement above a threshold is detected regardless of the CE's detection output.

The example process 1700 shown in FIG. 17A may begin at step 1701. At step 1701, the device (e.g., the UE 111-116 of FIGS. 1 and 3 and/or components thereof such as the processor 340) may determine whether a user movement is greater than a threshold. At step 1702, if the movement is greater than the threshold, the device may treat the user as no longer being in the spatial context. At step 1703, if the movement is not greater than the threshold, the device may determine that the user is still in the spatial context.

In the example process 1710 of FIG. 17B, the condition may be slightly relaxed to allow some movement. The example process 1710 may begin at step 1711. At step 1711, the device may determine whether a user movement is greater than a threshold. At step 1712, if the movement is not greater than the threshold, the device may determine that the user is still in the spatial context. At step 1713, if the movement is greater than the threshold, the device may determine whether the movement constitutes a persistent movement lasting longer than a first duration T1. For the user to move out of a spatial context, some persistence in the movement direction (e.g., when walking toward a fixed direction) may be expected. Only when detecting such a persistent movement (e.g., when inferred from the IMU or accelerometer reading that the user maintains some velocity for some duration), the optimization may be disabled. At step 1714, if the persistent movement lasts longer than T1, the device may treat the user as no longer being in the spatial context. At step 1715, if the movement is not a persistent movement, the device may determine whether the movement lasts longer than a second duration T2. If the movement does not last longer than T2, the device may determine that the user is still in the spatial context (step 1712). If the movement lasts longer than T2, the device may treat the user as no longer being in the spatial context (step 1714). Although the movement is not persistent in any fixed direction, if the movement is detected for too long a duration (e.g., T2), there may be too much uncertainty, and the user may be treated as no longer being in the spatial context.

FIG. 18 illustrates an example process 1800 for applying disruptive optimization modes in wireless communication systems in accordance with example embodiments of the present disclosure. The example process shown in FIG. 18 is for illustration only, and could have the same or similar configuration. One or more of the components illustrated in FIG. 18 may be implemented in specialized circuitry configured to perform the noted functions or one or more of the components may be implemented by one or more processors executing instructions to perform the noted functions. Other embodiments of the disruptive optimization mode application in accordance with the present disclosure could be used without departing from the scope of this disclosure. FIG. 18 does not limit the scope of this disclosure to any particular embodiment of the disruptive optimization mode application.

Depending on the optimization target, which may be non-disruptive or disruptive, further restrictions may be applied. A disruptive optimization mode (solution) may be a solution that may utilize some reset time during which the connectivity may be disrupted. For example, switching RAT or turning off some physical antennas may cause such a disruptive duration. Non-disruptive solutions may be those that may be performed quickly with a short or negligible disruption duration. For example, some mechanisms based on the UAI (UE assistance information) may allow the UE to request some changes in the configuration while maintaining the current connectivity, and thus may be considered as non-disruptive. The example processes 1700-1710 may apply to non-disruptive optimization solutions. For disruptive solutions, additional restrictions may be added as shown in FIG. 18.

The example process 1800 shown in FIG. 18 may begin at step 1801. At step 1801, the device (e.g., the UE 111-116 of FIGS. 1 and 3 and/or components thereof such as the processor 340) may determine whether the optimization mode is disruptive. At step 1802, if the optimization mode is not disruptive, the device may apply the optimization mode. At step 1803, if the optimization mode is disruptive, the device may check for the current application type. At step 1804, the device may determine whether the current application is a real time application. If it is not a real time application, the device may apply the optimization mode (step 1802). At step 1805, if the current application is a real time application, the device may not apply the optimization solution.

To reduce potentially negative impacts, disruptive solutions may be applied only for a certain class of applications, such as non-real-time and/or applications with bursty or sporadic traffic. In such cases, when a precursor for the moving out of spatial context is detected, the device may wait for the appropriate time (e.g., during the interval between data bursts for applications with bursty or sporadic traffic) to disable the optimization. Since there is no traffic in between data burst, the disruption during this time may not cause anything noticeable to the user. This may be generally applicable to all non-real-time applications. While there may be a dip in the data rate (if the non-real-time application does not have bursty or sporadic traffic), it may have minimal (if any) impact on the user experience.

For some spatial contexts, opportunistically, there may be cases where additional information may be used such as Bluetooth® connection or UWB ranging measurements etc., to some fixed devices that may allow some refinement in the precision. For example, the original spatial context from the CE may provide only a room-level precision, but in some cases like when the user has a monitor or desktop with Bluetooth® (potentially with some additional condition such as the signal strength greater than a threshold to ensure physical proximity to the fixed device), if the UE device can detect the Bluetooth® connection to the fixed device, it can be deduced that the UE may be at the vicinity of the desk where the device is. This may be helpful for cases where those refined locations are the locations at which the user spends the most time and the original CE may have a very low location precision. In this case, assume the device has accumulated the data for the spatial context A, and that in one part of this spatial context there may be an immobile device (e.g., a TV or some appliances) that may refine the precision. In this case, if the Bluetooth® connection may be detected along with the spatial context A. The spatial context A and the Bluetooth® connection may be combined to a particular device(s) as a new spatial context. The database entry for the new spatial context may start by copying the contents for the spatial context A and update in a similar manner as a regular context and over time it would adapt better to this new and more precise spatial context.

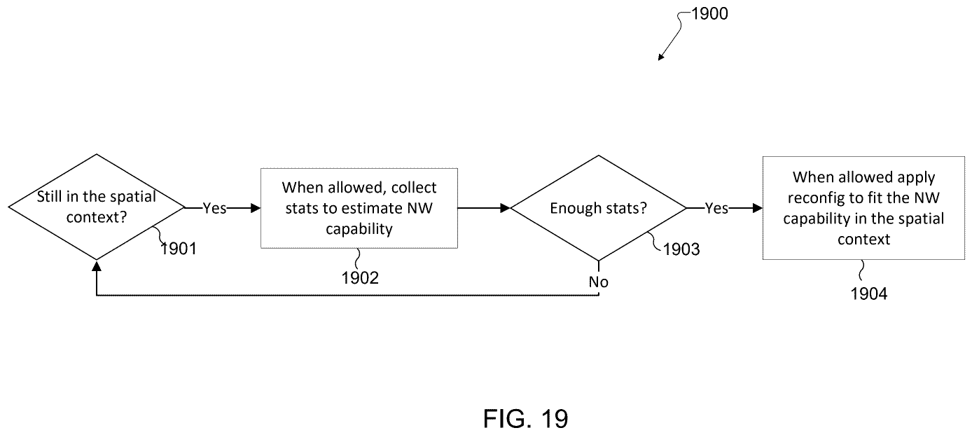

FIGS. 19-21 illustrate example processes 1900, 2000, 2100 for using spatial contexts as an anchor point for on-device learning for UE performance optimization in wireless communication systems in accordance with example embodiments of the present disclosure. The example processes shown in FIGS. 19-21 are for illustration only, and could have the same or similar configuration. One or more of the components illustrated in FIGS. 19-21 may be implemented in specialized circuitry configured to perform the noted functions or one or more of the components may be implemented by one or more processors executing instructions to perform the noted functions. Other embodiments of the disruptive optimization mode application in accordance with the present disclosure could be used without departing from the scope of this disclosure. FIGS. 19-21 do not limit the scope of this disclosure to any particular embodiment of the disruptive optimization mode application.

In one embodiment, the solutions described so far could be used to learn to optimize the UE configurations to fit what is supportable by the NW at some given location (i.e., a spatial context) as shown in FIG. 19. The example process 1900 shown in FIG. 19 may begin at step 1901. At step 1901, the device (e.g., the UE 111-116 of FIGS. 1 and 3 and/or components thereof such as the processor 340) may determine whether the user is still in the spatial context. At step 1902, if the user is still in the spatial context, the device may, when allowed, collect the statistics to estimate the NW capability. At step 1903, the device may determine whether a sufficient amount of the statistics have been collected. If no, the device may determine whether the user is still in the spatial context (step 1901). At step 1904, if a sufficient amount of the statistics have been collected, the device may apply a reconfiguration to fit the NW capability in the spatial context.

Parameters such as the maximum supportable MIMO layers and RAT may be the target for the optimization. In some locations, it may happen that only 4G RAT is available, while in some locations the largest MIMO layers observed to be used in the past may be up to only two. In such a situation, when the spatial context is detected and the condition allows, the UE may initiate the change of the corresponding configurations. In other cases, it may happen that the largest configuration (e.g., maximum number of MIMO layers in 5G RAT) was observed but they happen with a very low probability. Some tradeoff may be applied in this case considering the battery level and the potential boost in the performance. The potential boost in the performance may be computed from the specifications and/or theoretical models, or determined empirically from the recorded data when such configurations were active (e.g., based on the reported throughput). That is, a threshold may be selected as a function of the potential performance boost and the current battery level.

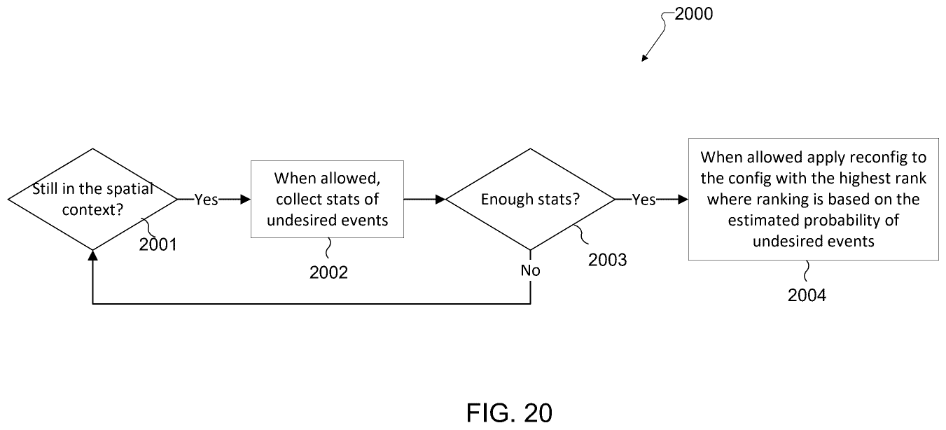

In another set of parameters, the selection may be based on occurrences of undesired events as illustrated in FIG. 20. Such events may be some failure events (e.g., random access failure, secondary cell group failure, out-of-sync events, etc.) or some costly events such as frequent cell-reselection. These events may be observed for some particular RAT and/or frequency band(s) and/or cell(s). In this case, the recorded events may be utilized to estimate the probability of such undesired events to rank the RAT and/or bands and/or cells. Note that different types of undesired events may be weighted differently. For example, a failure event may be weighted higher than a frequency reselection event (which may consume some extra power but otherwise no impact on user experience).

The example process 2000 shown in FIG. 20 may begin at step 2001. At step 2001, the device (e.g., the UE 111-116 of FIGS. 1 and 3 and/or components thereof such as the processor 340) may determine whether the user is still in the spatial context. At step 2002, if the user is still in the spatial context, the device may, when allowed, collect the statistics of the undesired events. At step 2003, the device may determine whether a sufficient amount of the statistics have been collected. If no, the device may determine whether the user is still in the spatial context (step 2001). At step 2004, if a sufficient amount of the statistics have been collected, the device may apply a reconfiguration to the configuration with the highest rank where ranking is based on the estimated probability of the undesired events.

In another implementation, the undesired events may be grouped into critical (e.g., failure events) and non-critical (e.g., cell or frequency reselection events) categories, and the ranking may be first made using the probability of the critical events and for those with similar probability of critical events (e.g., based on some quantized range of the probability values), further ranking may be determined using the probability of non-critical events.

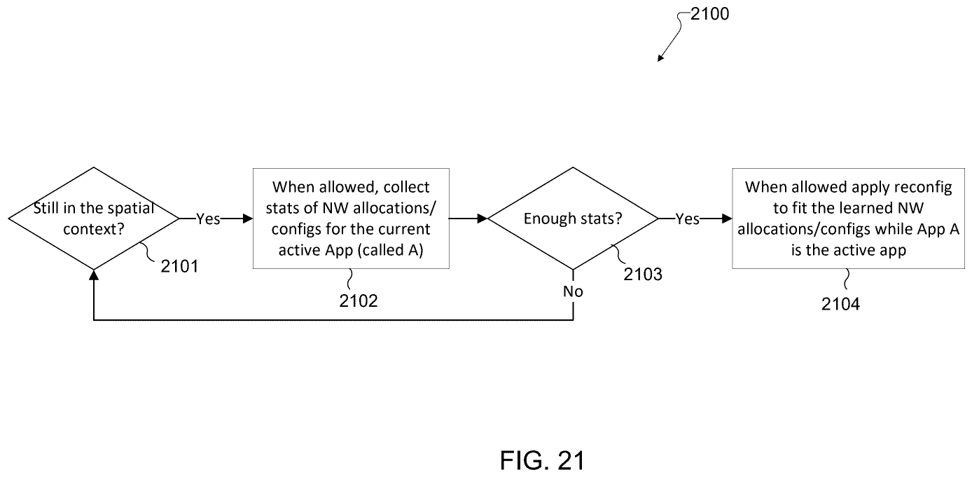

In another embodiment, the optimization may be applied in conjunction with the usage pattern of an active application on the device as shown in FIG. 21. The example process 2100 shown in FIG. 21 may begin at step 2101. At step 2101, the device (e.g., the UE 111-116 of FIGS. 1 and 3 and/or components thereof such as the processor 340) may determine whether the user is still in the spatial context. At step 2102, if the user is still in the spatial context, the device may, when allowed, collect the statistics of the NW allocations and/or configurations for the current active application. At step 2103, the device may determine whether a sufficient amount of the statistics have been collected. If no, the device may determine whether the user is still in the spatial context (step 2101). At step 2104, if a sufficient amount of the statistics have been collected, the device may apply a reconfiguration to fit the learned NW allocations and/or configurations while the current active application remains active.

Consider the number of MIMO layers as an example. Although, in the spatial context, the maximum number of layers was observed to be four, when running an application (e.g. App A), it was observed that the UE was assigned only up to two layers or assigned four layers with a very low probability (e.g., less than 1%). In such a case, selecting the maximum number of MIMO layers to be two may be a better choice when in the spatial context and the user is using the App A. In this case, the optimization mode may be considered as a form of context augmentation where both the absolute spatial context and the application ID may be incorporated as a new type of context. This optimization may be applied similarly for RAT as well as the maximum number of component carriers and bandwidth.

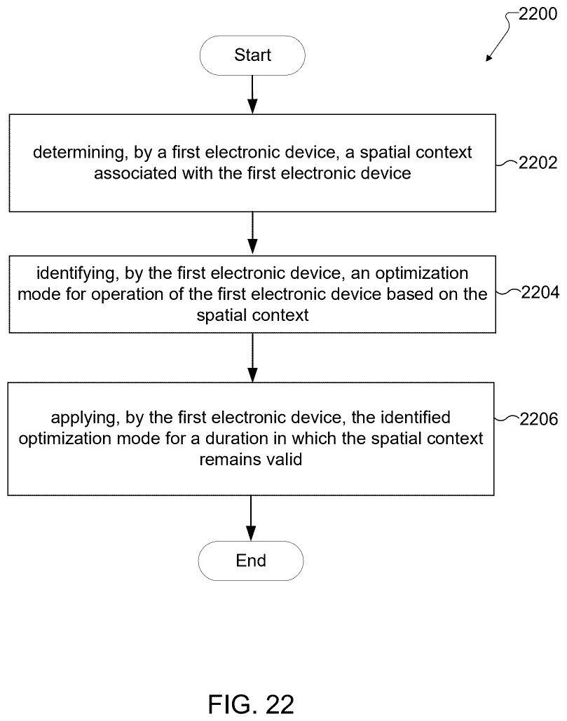

FIG. 22 illustrates a flow chart of a method 2200 for UE performance optimization using spatial contexts in wireless communication systems in accordance with example embodiments of the present disclosure. The embodiment of the UE performance optimization method in FIG. 22 is for illustration only. Other embodiments of the UE performance optimization methods may be used without departing from the scope of this disclosure. In the example of FIG. 22, the UE performance optimization method 2200 may be performed by a first electronic device (such as a UE 111-116 of FIGS. 1 and 2 or components thereof).

In the example of FIG. 22, the method 2200 may begin at step 2202. At step 2202, the first electronic device may determine a spatial context associated with the first electronic device.

At step 2204, the first electronic device may identify an optimization mode for operation of the first electronic device based on the spatial context. In one embodiment, based on a determination that the spatial context is an abstract spatial context associated with an environment for the first electronic device, the device may identify the optimization mode associated with the abstract spatial context and determine whether a condition for the optimization mode associated with the abstract spatial context is satisfied. In one embodiment, based on a determination that the spatial context is an absolute spatial context associated with a location within the environment, the device may collect data associated with the absolute spatial context, and identify the optimization mode associated with the absolute spatial context based on the collected data. In one embodiment, based on a determination that the spatial context is an absolute spatial context, the device may collect data associated with the absolute spatial context, determine whether an abstract spatial context is detected based on insufficiency of the collected data, and identify the optimization mode associated with the detected abstract spatial context.

At step 2206, the first electronic device may apply the identified optimization mode for a duration in which the spatial context remains valid.

In one embodiment, the spatial context may be an abstract spatial context including a private place context, the abstract spatial context associated with an environment for the first electronic device. The identified optimization mode may include a radio resource measurement (RRM) reduction. The first electronic device may apply the identified optimization mode by determining whether the first electronic device is static without associated data activity, and performing the RRM measurement reduction based on at least one of a determination that the first electronic device is static without the associated data activity, a surrounding movement less than a threshold, and a prediction that the next RRM measurement occasion is to be skipped. Alternatively or in addition, first electronic device may apply the identified optimization mode by obtaining sensor data associated with the first electronic device in response to determining that the first electronic device is static without the associated data activity, and performing the RRM measurement reduction based on at least one of a determination that the first electronic device is static without the associated data activity, a surrounding movement less than a threshold, and a prediction that the next RRM measurement occasion is to be skipped. Alternatively or in addition, first electronic device may apply the identified optimization mode by predicting whether a next RRM measurement occasion is to be skipped based on the sensor data and past RRMs using an RRM predictor and performing the RRM measurement reduction based on at least one of a determination that the first electronic device is static without the associated data activity, a surrounding movement less than a threshold, and a prediction that the next RRM measurement occasion is to be skipped.

In one embodiment, the spatial context may be an abstract spatial context including a public place context. The abstract spatial context may be associated with an environment for the first electronic device, and the public place context may include a density of users associated with the public place context. The first electronic device may identify the optimization mode by selecting a communication algorithm and configuration parameters based on the public place context, the communication algorithm including a channel estimation and prediction algorithm. The first electronic device may select the communication algorithm and the configuration parameters by collecting wireless channels associated with the public place context, fine-tuning the channel estimation and prediction algorithm based on the collected wireless channels, and selecting the configuration parameters based on the collected wireless channels.

In one embodiment, the spatial context may be an abstract spatial context including an in-vehicle context. The abstract spatial context may be associated with an environment for the first electronic device. The first electronic device may identify the optimization mode by at least one of reducing a handover cost and selecting a communication algorithm and configuration parameters based on the in-vehicle context. The first electronic device may reduce the handover cost by determining data usage associated with the first electronic device based on user habit or an on-device learning component configured to track data usage demand associated with the first electronic device, and switching to a frequency band based on the data usage demand lower than a threshold.

In one embodiment, the spatial context may be an absolute spatial context associated with a location of the first electronic device. The first electronic device may identify the optimization mode by collecting current data including at least one of a first data type unaffected by the identified optimization mode and a second data type collected upon disabling the identified optimization mode; determining whether the current data is consistent with past data collected associated with the absolute spatial context; in response to determining that the current data is consistent with the past data, determining whether a condition for the identified optimization mode is satisfied; and in response to determining that the condition for the identified optimization mode is satisfied, continuing the collection of the second data type, or terminating the current data collection and applying the identified optimization mode.

In one embodiment, the first electronic device may further identify a movement of the first electronic device using a sensor, the movement including an exit from the spatial context, determine whether the movement is greater than a first threshold, and in response to determining that the movement is not greater than the first threshold, determine that the first electronic device remains in the spatial context.

In one embodiment, the first electronic device may further identify a movement of the first electronic device using a sensor, the movement including an exit from the spatial context, determine whether the movement is greater than a first threshold, and in response to determining that the movement is greater than the first threshold, determine whether the movement persists in a fixed direction for a duration longer than a first period. Also, the first electronic device may, in response to a determination that the movement does not persist in the fixed direction for the duration longer than the first period, determine whether the movement occurs for a duration longer than a second period. In addition, the first electronic device may, in response to a determination that the movement does not occur for the duration longer than the second period, determine that the first electronic device remains in the spatial context.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
determining, by a first electronic device, a spatial context associated with the first electronic device;
identifying, by the first electronic device, an optimization mode for operation of the first electronic device based on the spatial context; and
applying, by the first electronic device, the identified optimization mode for a duration in which the spatial context remains valid.

2. The method of claim 1, wherein identifying the optimization mode comprises one of:
based on a determination that the spatial context is an abstract spatial context associated with an environment for the first electronic device, identifying the optimization mode associated with the abstract spatial context, and determining whether a condition for the optimization mode associated with the abstract spatial context is satisfied;
based on a determination that the spatial context is an absolute spatial context associated with a location within the environment, collecting data associated with the absolute spatial context, and identifying the optimization mode associated with the absolute spatial context based on the collected data; or
based on a determination that the spatial context is an absolute spatial context, collecting data associated with the absolute spatial context, determining whether an abstract spatial context is detected based on insufficiency of the collected data, and identifying the optimization mode associated with the detected abstract spatial context.

3. The method of claim 1, wherein:
the spatial context is an abstract spatial context including a private place context, the abstract spatial context associated with an environment for the first electronic device;
the identified optimization mode includes a radio resource measurement (RRM) reduction; and
applying the identified optimization mode comprises:
at least one of:
determining whether the first electronic device is static without associated data activity;
in response to determining that the first electronic device is static without the associated data activity, obtaining sensor data associated with the first electronic device; and
predicting whether a next RRM measurement occasion is to be skipped based on the sensor data and past RRMs using an RRM predictor; and
performing the RRM measurement reduction based on at least one of a determination that the first electronic device is static without the associated data activity, a surrounding movement less than a threshold, and a prediction that the next RRM measurement occasion is to be skipped.

4. The method of claim 1, wherein:
the spatial context is an abstract spatial context including a public place context, the abstract spatial context associated with an environment for the first electronic device, the public place context including a density of users associated with the public place context; and
identifying the optimization mode comprises selecting a communication algorithm and configuration parameters based on the public place context, the communication algorithm including a channel estimation and prediction algorithm; and
selecting the communication algorithm and the configuration parameters comprises:
collecting wireless channels associated with the public place context;
fine-tuning the channel estimation and prediction algorithm based on the collected wireless channels; and
selecting the configuration parameters based on the collected wireless channels.

5. The method of claim 1, wherein:
the spatial context is an abstract spatial context including an in-vehicle context, the abstract spatial context associated with an environment for the first electronic device;
identifying the optimization mode comprises at least one of reducing a handover cost and selecting a communication algorithm and configuration parameters based on the in-vehicle context; and
reducing the handover cost comprises:
determining data usage associated with the first electronic device based on user habit or an on-device learning component configured to track data usage demand associated with the first electronic device; and
switching to a frequency band based on the data usage demand lower than a threshold.

6. The method of claim 1, wherein:
the spatial context is an absolute spatial context associated with a location of the first electronic device; and
identifying the optimization mode comprises:
collecting current data including at least one of a first data type unaffected by the identified optimization mode and a second data type collected upon disabling the identified optimization mode;
determining whether the current data is consistent with past data collected associated with the absolute spatial context;
in response to determining that the current data is consistent with the past data, determining whether a condition for the identified optimization mode is satisfied; and
in response to determining that the condition for the identified optimization mode is satisfied, continuing the collection of the second data type, or terminating the current data collection and applying the identified optimization mode.

7. The method of claim 1, further comprising:
identifying, by the first electronic device, a movement of the first electronic device using a sensor, the movement including an exit from the spatial context;
determining, by the first electronic device, whether the movement is greater than a first threshold; and
in response to determining that the movement is not greater than the first threshold, determining that the first electronic device remains in the spatial context; or
in response to determining that the movement is greater than the first threshold, determining whether the movement persists in a fixed direction for a duration longer than a first period, and in response to a determination that the movement does not persist in the fixed direction for the duration longer than the first period, determining whether the movement occurs for a duration longer than a second period, and in response to a determination that the movement does not occur for the duration longer than the second period, determining that the first electronic device remains in the spatial context.

8. A first electronic device comprising:
memory; and
a processor operably coupled to the memory, the processor configured to:
determine a spatial context associated with the first electronic device;
identify an optimization mode for operation of the first electronic device based on the spatial context; and
apply the identified optimization mode for a duration in which the spatial context remains valid.

9. The first electronics device of claim 8, wherein to identify the optimization mode the processor is further configured to:
based on a determination that the spatial context is an abstract spatial context associated with an environment for the first electronic device, identify the optimization mode associated with the abstract spatial context, and determine whether a condition for the optimization mode associated with the abstract spatial context is satisfied;
based on a determination that the spatial context is an absolute spatial context associated with a location within the environment, collect data associated with the absolute spatial context, and identify the optimization mode associated with the absolute spatial context based on the collected data; or
based on a determination that the spatial context is an absolute spatial context, collect data associated with the absolute spatial context, determine whether an abstract spatial context is detected based on insufficiency of the collected data, and identify the optimization mode associated with the detected abstract spatial context.

10. The first electronics device of claim 8, wherein:
the spatial context is an abstract spatial context including a private place context, the abstract spatial context associated with an environment for the first electronic device;
the identified optimization mode includes a radio resource measurement (RRM) reduction; and
to apply the identified optimization mode, the processor is further configured to:
at least one of:
determine whether the first electronic device is static without associated data activity;
in response to determining that the first electronic device is static without the associated data activity, obtain sensor data associated with the first electronic device; and
predict whether a next RRM measurement occasion is to be skipped based on the sensor data and past RRMs using an RRM predictor; and
perform the RRM measurement reduction based on at least one of a determination that the first electronic device is static without the associated data activity, a surrounding movement less than a threshold, and a prediction that the next RRM measurement occasion is to be skipped.

11. The first electronics device of claim 8, wherein:
the spatial context is an abstract spatial context including a public place context, the abstract spatial context associated with an environment for the first electronic device, the public place context including a density of users associated with the public place context; and
to identify the optimization mode, the processor is further configured to select a communication algorithm and configuration parameters based on the public place context, the communication algorithm including a channel estimation and prediction algorithm; and
to select the communication algorithm and the configuration parameters, the processor is further configured to:
collect wireless channels associated with the public place context;
fine-tune the channel estimation and prediction algorithm based on the collected wireless channels; and
select the configuration parameters based on the collected wireless channels.

12. The first electronics device of claim 8, wherein:
the spatial context is an abstract spatial context including an in-vehicle context, the abstract spatial context associated with an environment for the first electronic device;
to identify the optimization mode, the processor is further configured to reduce a handover cost and/or select a communication algorithm and configuration parameters based on the in-vehicle context; and
to reduce the handover cost, the processor is further configured to:
determine data usage associated with the first electronic device based on user habit or an on-device learning component configured to track data usage demand associated with the first electronic device; and
switch to a frequency band based on the data usage demand lower than a threshold.

13. The first electronic device of claim 8, wherein:
the spatial context is an absolute spatial context associated with a location of the first electronic device; and
to identify the optimization mode, the processor is further configured to:
collect current data including at least one of a first data type unaffected by the identified optimization mode and a second data type collected upon disabling the identified optimization mode;
determine whether the current data is consistent with past data collected associated with the absolute spatial context;
in response to determining that the current data is consistent with the past data, determine whether a condition for the identified optimization mode is satisfied; and
in response to determining that the condition for the identified optimization mode is satisfied, continue the collection of the second data type, or terminate the current data collection and apply the identified optimization mode.

14. The first electronic device of claim 8, wherein the processor is further configured to:
identify a movement of the first electronic device using a sensor, the movement including an exit from the spatial context;
determine whether the movement is greater than a first threshold; and
in response to determining that the movement is not greater than the first threshold, determine that the first electronic device remains in the spatial context; or
in response to determining that the movement is greater than the first threshold, determine whether the movement persists in a fixed direction for a duration longer than a first period, and in response to a determination that the movement does not persist in the fixed direction for the duration longer than the first period, determine whether the movement occurs for a duration longer than a second period, and in response to a determination that the movement does not occur for the duration longer than the second period, determine that the first electronic device remains in the spatial context.

15. A non-transitory computer readable medium embodying a computer program, the computer program comprising program code that, when executed by a processor of a first electronic device, causes the first electronic device to:
determine a spatial context associated with the first electronic device;
identify an optimization mode for operation of the first electronic device based on the spatial context; and
apply the identified optimization mode for a duration in which the spatial context remains valid.

16. The non-transitory computer readable medium of claim 15, wherein the program code that, when executed by the processor of the first electronic device, causes the first electronic device to identify the optimization mode comprises program code that, when executed by the processor of the first electronic device, causes the first electronic device to:
based on a determination that the spatial context is an abstract spatial context associated with an environment for the first electronic device, identify the optimization mode associated with the abstract spatial context, and determine whether a condition for the optimization mode associated with the abstract spatial context is satisfied;
based on a determination that the spatial context is an absolute spatial context associated with a location within the environment, collect data associated with the absolute spatial context, and identify the optimization mode associated with the absolute spatial context based on the collected data; or
based on a determination that the spatial context is an absolute spatial context, collect data associated with the absolute spatial context, determine whether an abstract spatial context is detected based on insufficiency of the collected data, and identify the optimization mode associated with the detected abstract spatial context.

17. The non-transitory computer readable medium of claim 15, wherein:
the spatial context is an abstract spatial context including a private place context, the abstract spatial context associated with an environment for the first electronic device;
the identified optimization mode includes a radio resource measurement (RRM) reduction; and
the program code that, when executed by the processor of the first electronic device, causes the first electronic device to apply the identified optimization mode comprises program code that, when executed by the processor of the first electronic device, causes the first electronic device to:
at least one of:
determine whether the first electronic device is static without associated data activity;
in response to determining that the first electronic device is static without the associated data activity, obtain sensor data associated with the first electronic device; and
predict whether a next RRM measurement occasion is to be skipped based on the sensor data and past RRMs using an RRM predictor; and
perform the RRM measurement reduction based on at least one of a determination that the first electronic device is static without the associated data activity, a surrounding movement less than a threshold, and a prediction that the next RRM measurement occasion is to be skipped.

18. The non-transitory computer readable medium of claim 15, wherein:
the spatial context is an abstract spatial context including a public place context, the abstract spatial context associated with an environment for the first electronic device, the public place context including a density of users associated with the public place context; and
the program code that, when executed by the processor of the first electronic device, causes the first electronic device to identify the optimization mode comprises program code that, when executed by the processor of the first electronic device, causes the first electronic device to:
select a communication algorithm and configuration parameters based on the public place context, the communication algorithm including a channel estimation and prediction algorithm; and
the program code that, when executed by the processor of the first electronic device, causes the first electronic device to select the communication algorithm and the configuration parameters comprises program code that, when executed by the processor of the first electronic device, causes the first electronic device to:
collect wireless channels associated with the public place context;
fine-tune the channel estimation and prediction algorithm based on the collected wireless channels; and
select the configuration parameters based on the collected wireless channels.

19. The non-transitory computer readable medium of claim 15, wherein:
the spatial context is an abstract spatial context including an in-vehicle context, the abstract spatial context associated with an environment for the first electronic device;
the program code that, when executed by the processor of the first electronic device, causes the first electronic device to identify the optimization mode comprises program code that, when executed by the processor of the first electronic device, causes the first electronic device to reduce a handover cost and/or select a communication algorithm and configuration parameters based on the in-vehicle context; and
the program code that, when executed by the processor of the first electronic device, causes the first electronic device to reduce the handover cost comprises program code that, when executed by the processor of the first electronic device, causes the first electronic device to:
determine data usage associated with the first electronic device based on user habit or an on-device learning component configured to track data usage demand associated with the first electronic device; and
switch to a frequency band based on the data usage demand lower than a threshold.

20. The non-transitory computer readable medium of claim 15, wherein:
the spatial context is an absolute spatial context associated with a location of the first electronic device; and
the program code that, when executed by the processor of the first electronic device, causes the first electronic device to identify the optimization mode comprises program code that, when executed by the processor of the first electronic device, causes the first electronic device to:
collect current data including at least one of a first data type unaffected by the identified optimization mode and a second data type collected upon disabling the identified optimization mode;
determine whether the current data is consistent with past data collected associated with the absolute spatial context;
in response to determining that the current data is consistent with the past data, determine whether a condition for the identified optimization mode is satisfied; and
in response to determining that the condition for the identified optimization mode is satisfied, continue the collection of the second data type, or terminate the current data collection and apply the identified optimization mode.
